(19) United States
(12) Patent Application Publication
(10) Pub. No.: US 2007/0162953 A1
(43) Pub. Date: Jul. 12, 2007

(54) Media package and a system and method for managing a media package

(76) Inventors: David Peter Bolliger, North Bondi (AU); Xiaogang Zhang, Carlingford (AU); Morgan Lean, Manly (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/580,532

(22) Filed: Oct. 13, 2006

Related U.S. Application Data
(63) Continuation of application No. PCT/AU05/00530, filed on Apr. 14, 2005.

(30) Foreign Application Priority Data
Apr. 14, 2004 (AU) 2004901988
Jul. 28, 2004 (AU) 2004904230
Feb. 23, 2005 (AU) 2005900837

(51) Int. Cl. H04N 7/16; G06F 3/00; H04N 5/91; H04N 7/00; G06F 3/048

(52) U.S. Cl. 725/142; 715/700; 725/135; 386/46; 715/838; 715/841

(57) ABSTRACT

The present invention relates to a media package arranged to contain presentation elements. The invention also relates to a system and method for authoring, editing, delivering and viewing the media packages, and a graphical user interface which can interface with media packages.

### CROSS REFERENCE TO RELATED APPLICATIONS

This application is a continuation of PCT Patent Application No. PCT/AU2005/000530 filed on Apr. 14, 2005 which claims priorities of Australian Patent Application No. 2004901988 filed on Apr. 14, 2004 and of Australian Patent Application No. 2004904230 filed on Jul. 28, 2004, and of Australian Patent Application No. 2005900837 filed on Feb. 23, 2005, the disclosures of which are incorporated herein in their entirety by reference.

### FIELD OF THE INVENTION

The present invention relates to a media package and a method and system for authoring and displaying the media package. In the context of the specification, the term “media package” is used to denote a structure which may be utilised to contain at least one media file, whether logically or physically. A media file is a presentation element such as a video clip, audio clip or text document or data utilised in forming the presentation element, including scripts (or applications). More specifically, a media package may be used as a vehicle to assemble, organise and deliver a multimedia presentation to an audience. The present invention also relates to a graphical user interface acting as the front end of external applications.

### BACKGROUND OF THE INVENTION

The Internet has provided consumers with an unprecedented amount of information. Furthermore the distinction between the personal computer, the Internet and other forms of media such as Television, is blurring. One problem with the amount of information available is the problem of organising the data in a meaningful and searchable format. This is particularly the case where disparate forms of digital content need to be placed into a coherent grouping suitable for interchange between contexts. Another problem with the disparate forms of digital content is that the sheer number of file types and codecs requires the user to be familiar with an ever increasing number of applications.

Current methods of grouping and presenting various media were developed at a time when online and offline environments were distinct. These methods lack suitability to the current situation in which the lines between online, offline, “client side” and “server side” are blurring.

The most well known and widely recognised attempt at grouping disparate content is the webpage. HTML (hyper text mark-up language) is able to reference any file format. However it does so through linking to the file, rather than integrating the file. If a user saves an HTML page, the saved page does not include the contents. The contents linked by the page (e.g. video clips from mobile phones) are stored separately from the HTML, scattered within the directory tree of a file system.

Transporting a webpage to a new site may not work without technical knowledge of the entire directory of the original web site. This poses an obstacle to the standardization of meaningful subgroups of digital content and to the easy transplantation of these subgroups between contexts. Hyper-linking from one page to another page is possible, but even at this interface level the grouping mechanism is inadequate. A user sees each page but cannot see the structure as a whole, and each page of each site has a non-standard navigation structure.

It remains difficult for the average user to create, aggregate, publish and syndicate digital media. Between the individual and the relatively small set of activities they wish to participate in lies an army of professionals and a daunting array of software applications. Most of the content created by professionals is completely context bound. This makes it difficult or impossible to reuse or copy content to different contexts. This means many tasks are needlessly repeated, resulting in a great deal of expense, redundancy and wastage of effort. It also is one of the reasons for the proliferation of ad hoc interfaces, compounding the end user's problem.

Even professionals and content providers struggle with ways to display, convey and organise large amounts of related information into a coherent, easily searchable and intuitive interface.

Furthermore, automated presentation of content (as opposed to random browsing) is thwarted by each of these problems, because automation requires standards capable of combining, grouping, re-contextualizing displaying and playing content.

### SUMMARY OF THE INVENTION

In a first aspect, the present invention provides a media package comprising, storage means to contain or reference at least one presentation element, the media package being associable with another media package in order to link presentation elements between the media packages.

The media package may further comprise a linking structure operative to associate the media package with at least one other media package so as to link presentation elements between the media packages.

The linking structure may be capable of linking the media package to a plurality of other media packages so as to link presentation elements between the packages and the linking structure may be operable to establish a bi-directional link with the or each media package to which it is associated.

When a bi-directional link is established, the linking structure may be operative to include a variable in said link, the variable being operative to define one link as the primary link and the other link as the secondary link.

Any one of the primary and secondary link may establish a sequence in which presentation elements are linked so as to form a continuous presentation.

In one embodiment, on movement or modification of the media package, the media package causes a dummy file to be retained containing at least a sub-set of links of the media package, such that the other media packages referencing the media package are not affected by the movement or modification of the media package.

The dummy file may be a duplicate of the media package.

In another embodiment, on movement or modification of the media package, the media package causes all links of all other media packages referencing the media package to be updated to reflect the modification or movement of the media package.

In another variation, on movement or modification of the media package, the media package causes at least a sub-set of the links of other media packages referencing the media package to be updated to reflect the modification or movement of the media package.

In some embodiments, the at least sub-set of the links may be updated only when one of the other media packages attempts to access the moved or modified media package.

When conducting a search for similar media packages, the search may return a sub-set of media packages which are referenced by the media package, the sub-set returned being determined by a predetermined criteria.

The media package may further comprise a header section and a binary information store, the header section containing the associability information, and the binary information store containing the at least one presentation element.

In a second aspect, the present invention provides a method of delivering a media package in accordance with a first aspect of the invention, comprising the step of, in response to a user request, sending a copy of the media package to the user.

In a third aspect, the present invention provides a method of delivering a media package in accordance with a first aspect of the invention, comprising the steps of, delivering at least a sub-set of the header information to an end user and a representation of the at least one presentation element, and delivering at least a portion of the binary information to the user in response to a user request for the at least a portion of the binary information.

In a fourth aspect, the present invention provides a method of storing a presentation comprising the steps of providing a plurality of media packages according to a first aspect of the invention, storing presentation elements of the presentation in respective ones of the media packages, and linking the media packages so as to associate the presentation elements.

The method may comprise the further step of bi-directionally linking the media packages.

In a fifth aspect, the present invention provides a system for authoring, editing, storing and delivering a media package in accordance with a first aspect of the invention, the system comprising storage capable of storing the media package, a software application capable of delivering the media package to a client application on receipt of a request from the client application for the media package.

On receipt of a command from a media package to move or modify the media package, the system may cause a dummy file to be retained containing at least a sub-set of the original links of the media package, such that the other media packages referencing the media package are not affected by the movement or modification of the media package.

Alternatively, on receipt of a command from a media package to move or modify the media package, the system causes all links of all other media packages referencing the media package to be updated to reflect the modification or movement of the media package.

In still a further embodiment, on receipt of a command from a media package to move or modify the media package, the system causes all links of other media packages referencing the media packages to be updated to reflect the modification or movement of the media package only when one of the other media packages attempts to access the moved or modified media package.

The system may further comprise a search engine capable of reviewing the media packages stored and compiling a searchable index.

The system may comprise a plurality of servers interconnected via a computer network.

In a sixth aspect, the present invention provides a graphical user interface for displaying a plurality of media packages in accordance with a first aspect of the invention, comprising a plurality of display sections selectable by a user, including a first display section containing representations of media packages unique to a user, a second display section containing representations of media packages unique to other users, and a third display section arranged to allow authoring, editing or viewing of the media packages unique to the user or the other users.

The graphical user interface may further comprise a menu system viewable by selecting a media package contained within any one of the display sections, the menu system providing the functionality to manipulate the representation of the media package displayed therein.

The menu system may overlay the representation of the media package and may be invoked by movement of a cursor across the representation of the media package.

The menu system may further comprise a second menu surrounding each of the plurality of display sections, the menu providing the functionality to manipulate the media packages represented therein.

Manipulation of the media package may include the functions of copying the media package, editing the media package, deleting the media package and moving the media package to a new context.

Manipulation of the representation of the media package may include the functions of viewing the primary presentation element and viewing any of the further presentation elements.

In response to a user command, the representation of the presentation element may transform from the representation to a representation of all other presentation elements in the media package.

The transformation may occur through a virtual rotation of the representation, from a front face to a rear face.

The second display area may be limited to viewing representations of media packages accessible by only a sub-set of users.

The display sections contain at least one representation of a media package, the representation being provided within a pre-defined pattern, such as a grid pattern.

The layout of the graphical user interface may be determined by the contents of a selected media package.

In a seventh aspect, the present invention provides a graphical user interface comprising at least one viewing area arranged to display media content, wherein the layout of the graphical user interface is at least in part determined by the media content displayed in the at least one of the viewing areas.

The layout of the graphical user interface may include at least one menu system, the functionality of the menu system being determined by the media content displayed in a viewing area.

The menu system may include two sub-menus, the first sub-menu providing controls to manipulate the media content, the second sub-menu providing controls to manipulate the viewing of the media content in the interface.

The graphical user interface may further comprise blogging means capable of interfacing with a media package, the blogging means being capable of editing text comments in a media package.

In an eighth aspect, the present invention provides a system for viewing a plurality of media packages, comprising a computing system arranged to deliver at least a sub-set of one media package in accordance with any one of claims 1 to 13 to a graphical user interface, wherein the media package includes information that is used in establishing at least one characteristic that is operative in the graphical user interface.

In a ninth aspect, the present invention provides a method of customising a graphical user interface, comprising the steps of creating a media package including information that determines the layout and functionality of the graphical user interface, and delivering at least a sub-set of the media package containing the information to the graphical user interface.

In a tenth aspect, the present invention provides a method of creating a media package, comprising the steps of selecting at least one presentation element, and forming the presentation element into a media package.

In an eleventh aspect, the present invention provides a method of searching a plurality of media packages, comprising the steps of selecting a media package of interest to a user, identifying all media packages which are linked to the media package, and displaying a representation of at least some of the linked media packages.

In a twelfth aspect, the present invention provides a method of unifying presentation elements contained in a plurality of media packages, comprising the steps of, selecting a series of media packages, extracting a sub-set of presentation elements from the selected media packages, and constructing a further media package containing the extracted sub-set of presentation elements.

In a thirteeth aspect, the present invention provides a system for delivering a presentation comprising a device including a software application arranged to receive at least a sub-set of one media package in accordance with any one of claims 1 to 13 and display the at least one sub-set of the media package to a user.

The media package may contain streamed data, which may be from a live source, such as a video conference call.

The streamed data may include a series of presentation elements contained within the media package, the series of presentation elements being presented in a sequence.

In a thirteenth aspect, the present invention provides a method of distributing content to a plurality of users, comprising the steps of, assembling a media package in accordance with any one of claims 1 to 13, and distributing the media package to a number of users.

In a fourteenth aspect, the present invention provides a method of providing a self-executing media presentation to a user, comprising the steps of grouping at least one presentation element into a media package in accordance with any one of claims 1 to 13, and providing the media package to the user, wherein the user may view the at least one presentation element.

In a fifteenth aspect, the present invention provides a method of videoconferencing, comprising the steps of, providing a media package including a script capable of initiating a video conference and forwarding the tile to a user, wherein the video conference is initiated on receipt and confirmation by the user.

### DETAILED DESCRIPTION OF THE DRAWINGS

Notwithstanding any other forms which may fall within the scope of the present invention, a preferred embodiment will now be described, by way of example only, with reference to the accompanying drawings in which:

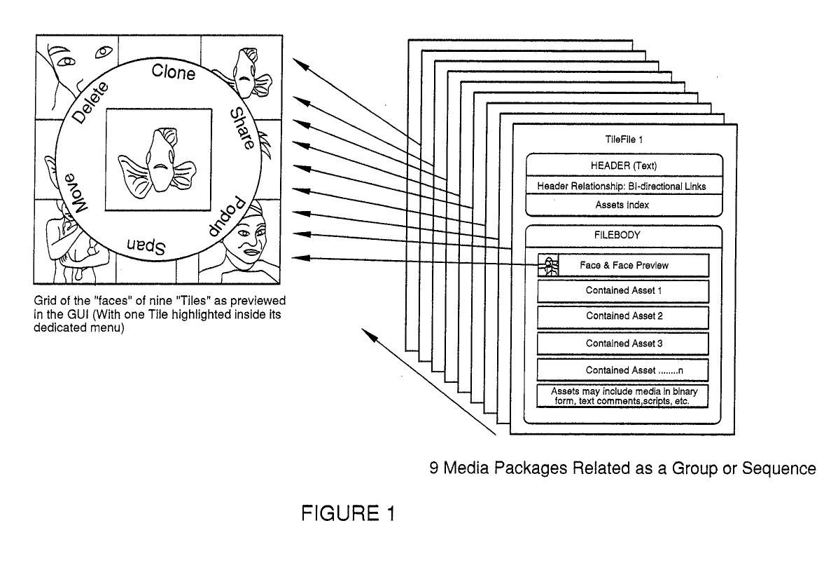

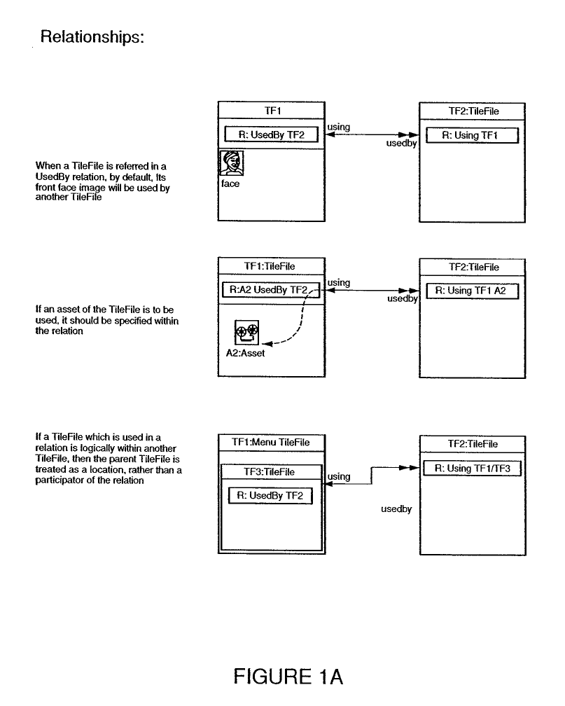

FIG. 1 is a diagram illustrating the structure of a media package in accordance with an embodiment of the present invention;

FIG. 1a is a diagram illustrating how media packages are linked, in accordance with an embodiment of the present invention;

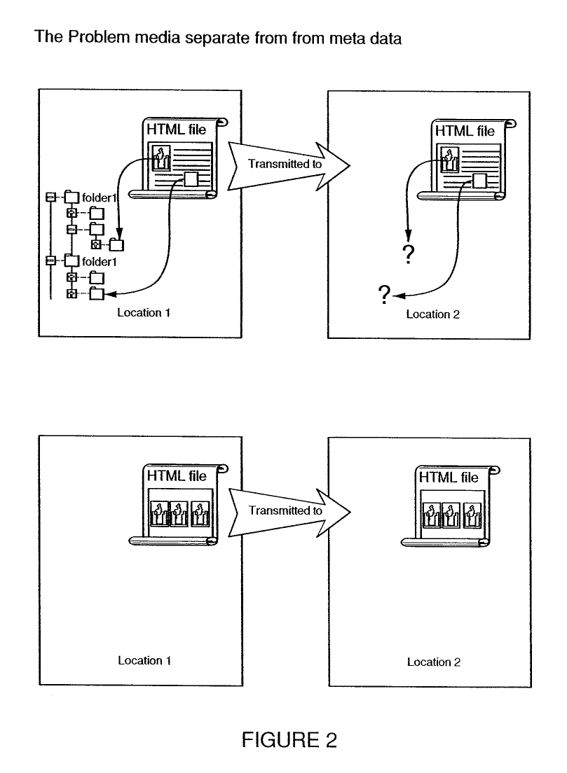

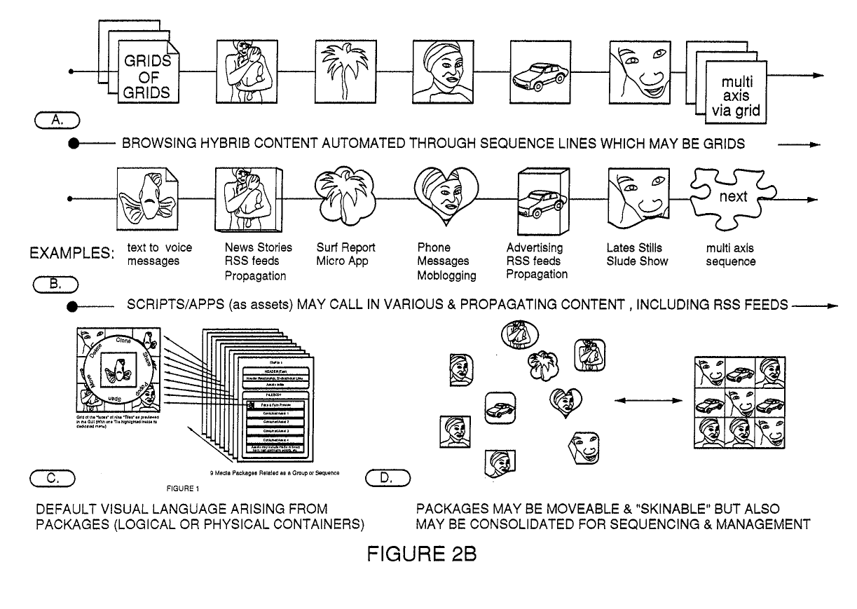

FIG. 2 and 2b are diagrams illustrating the portability of a media package from one location to another;

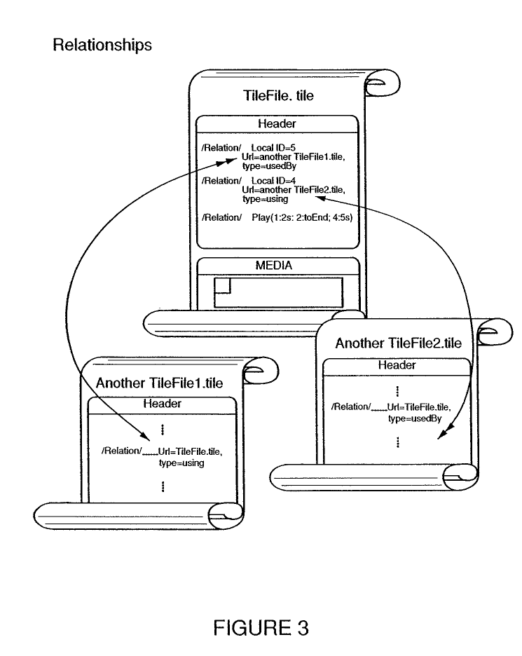

FIG. 3 is a diagram illustrating how a bi-directional link operates between media packages;

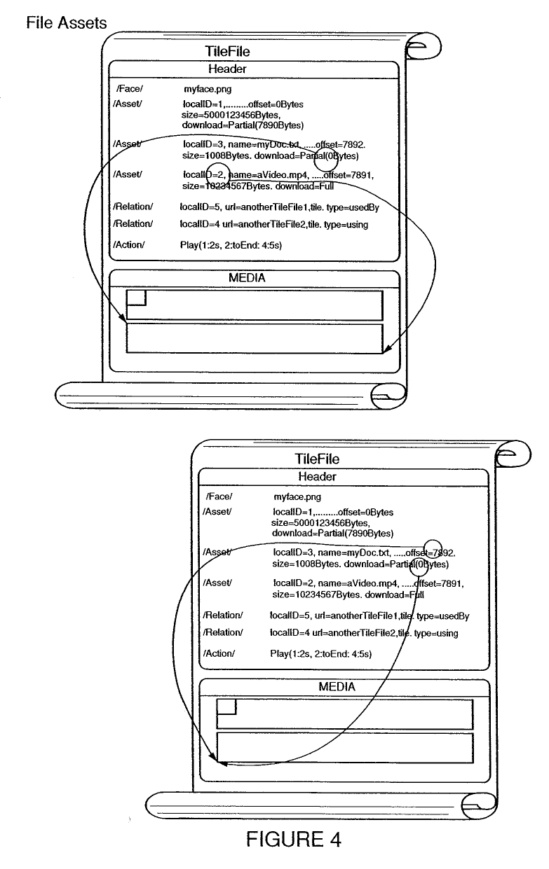

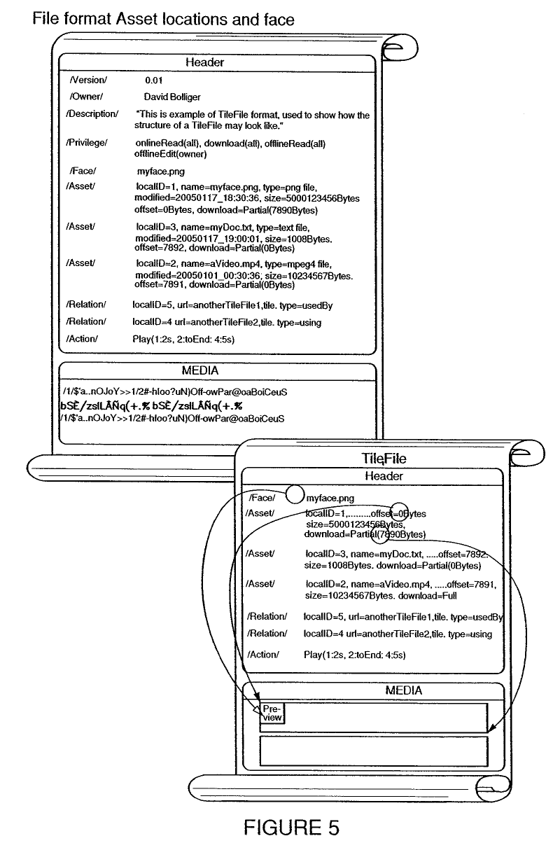

FIGS. 4 and 5 are diagrams illustrating how the header and media sections of a tile file are linked;

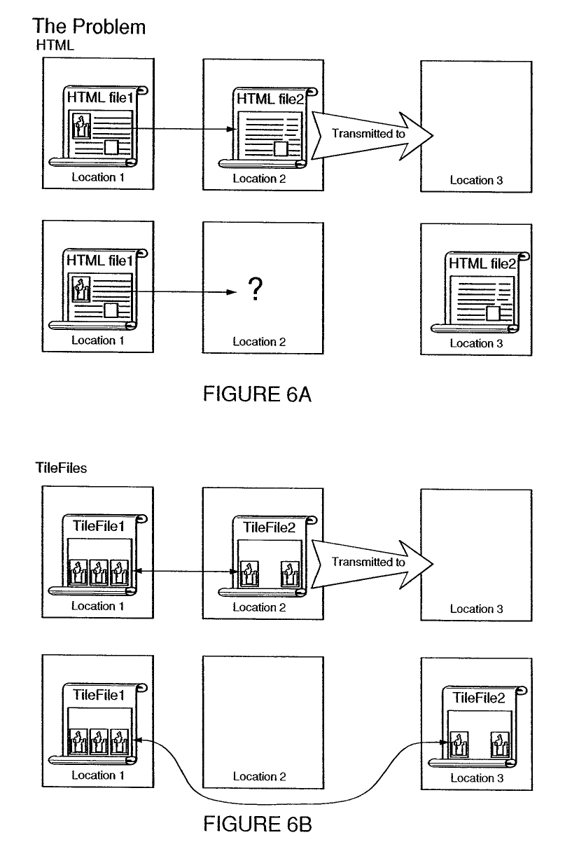

FIG. 6 is a diagram comparing a HTML document of the prior art with a media package in accordance with an embodiment of the present invention;

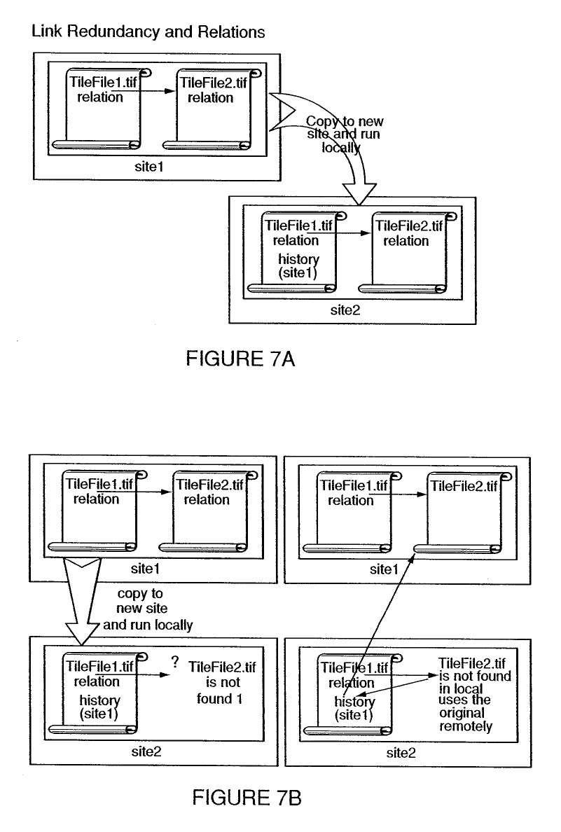

FIGS. 7a and 7b are diagrams illustrating the portability of a media package in accordance with an embodiment of the present invention;

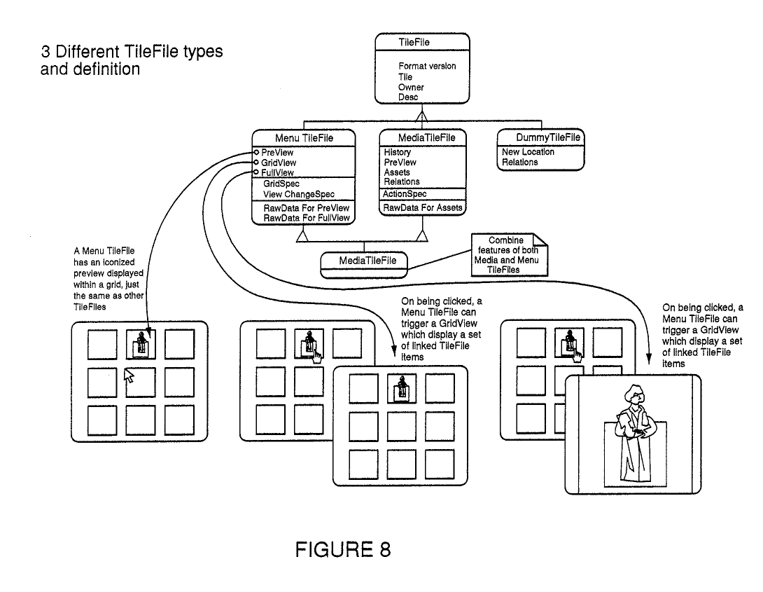

FIG. 8 is a diagram illustrating the links between a media package and a graphical user interface in accordance with an embodiment of the present invention;

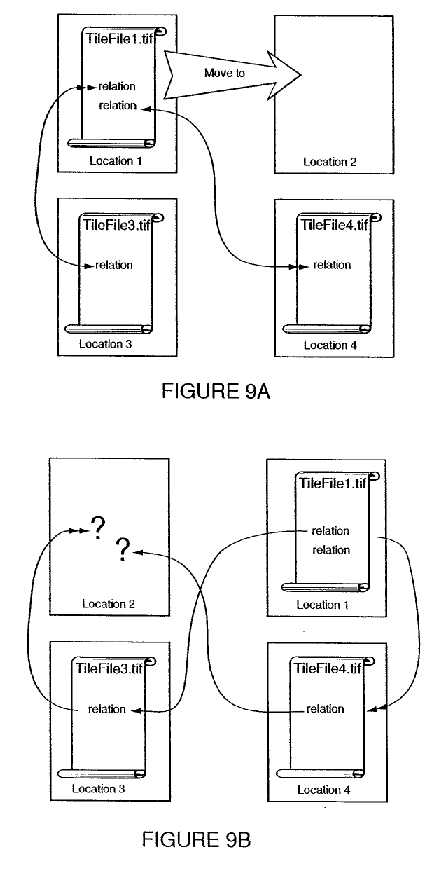

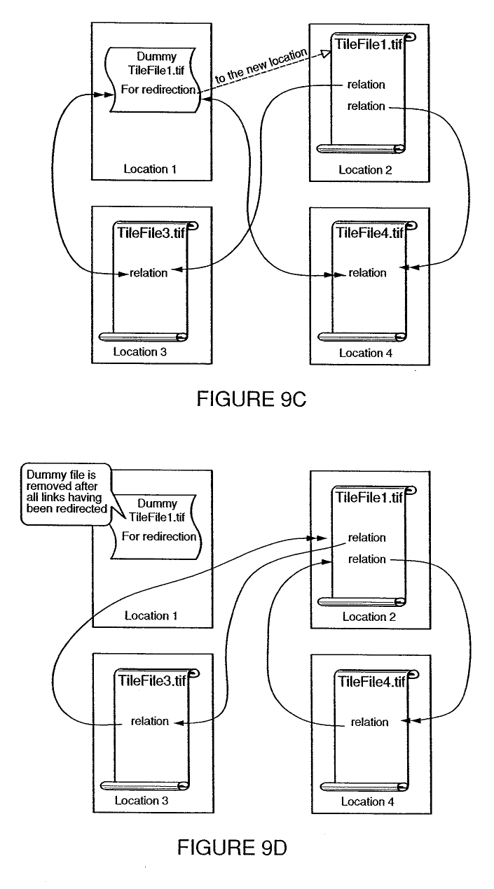

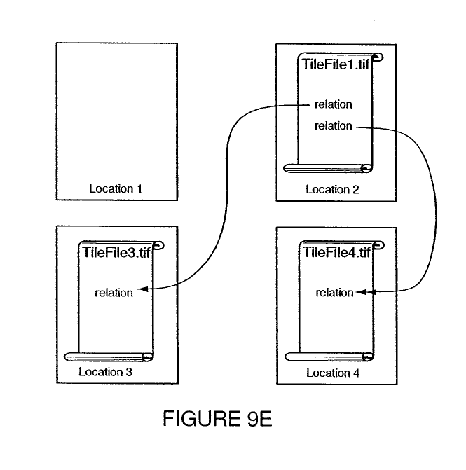

FIGS. 9a to 9e are diagrams illustrating the dynamic linking between media packages in accordance with an embodiment of the present invention;

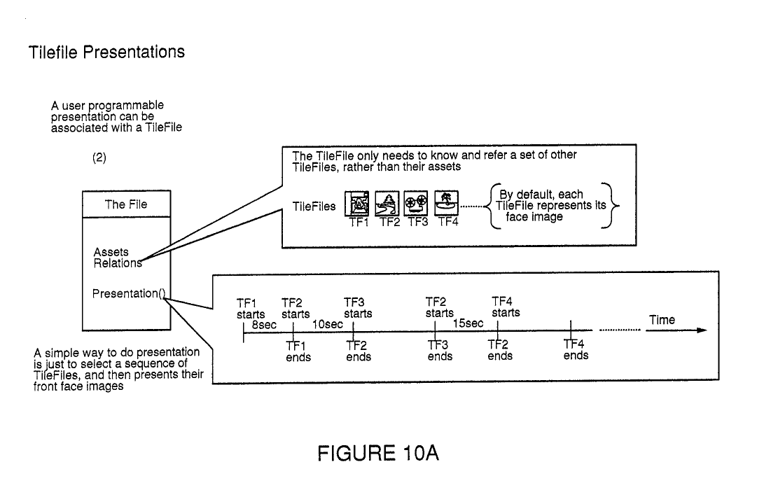

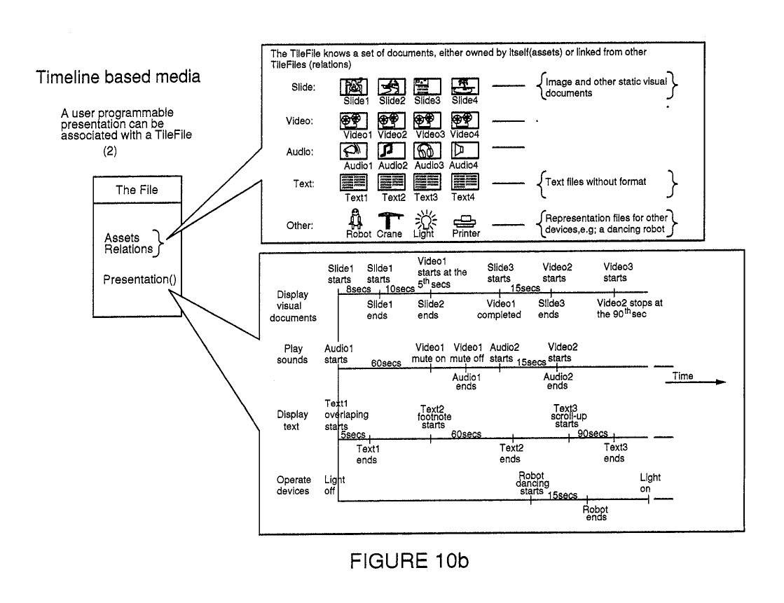

FIGS. 10a and 10b are diagrams illustrating the types of content that may be placed in a media package in accordance with an embodiment of the present invention;

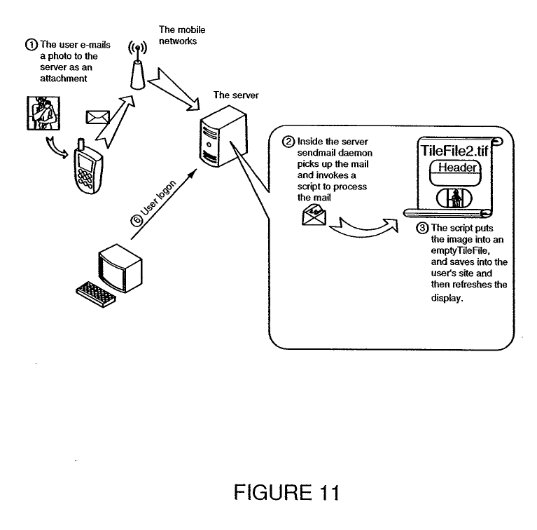

FIG. 11 is an example of the type of network which may interface with a system for producing media packages in accordance with an embodiment of the present invention; and

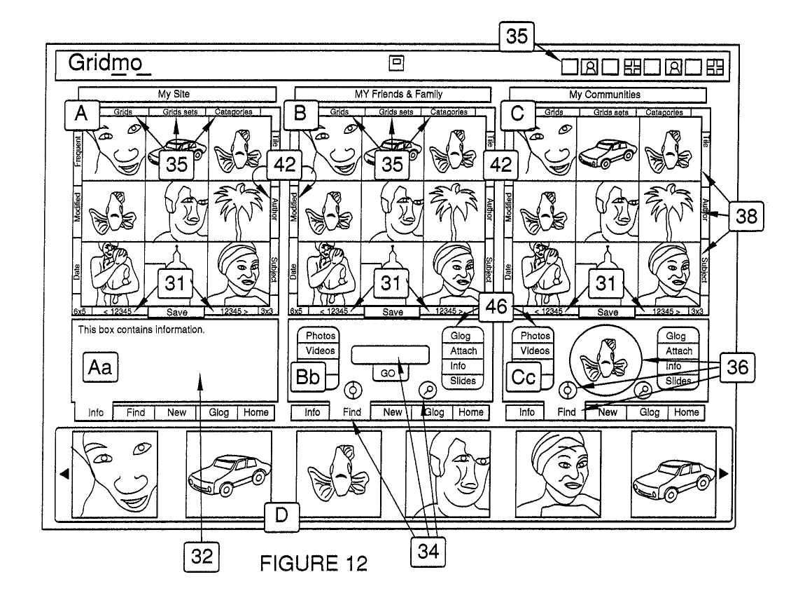

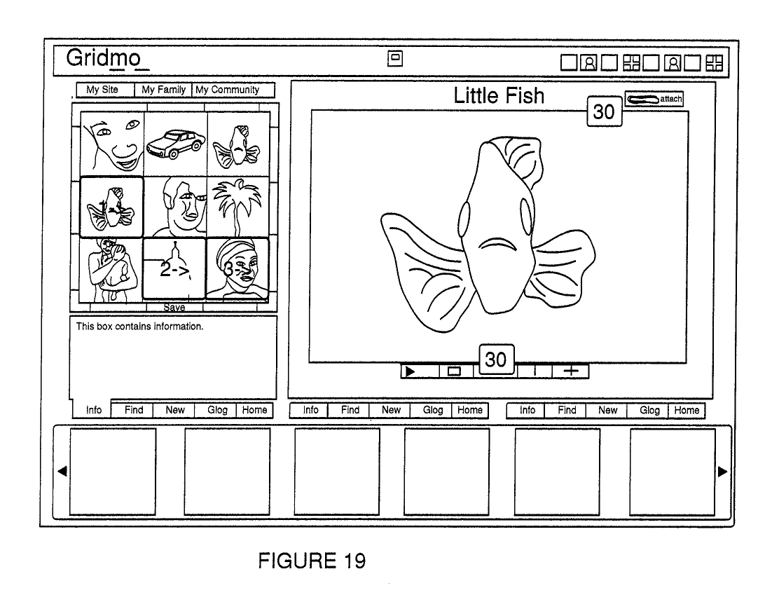

FIGS. 12, 13, 14A, 14B, 15, 16, 17, 18 and 19 are illustrations of a graphical user interface in accordance with an embodiment of the present invention.

### DESCRIPTION OF SPECIFIC EMBODIMENTS

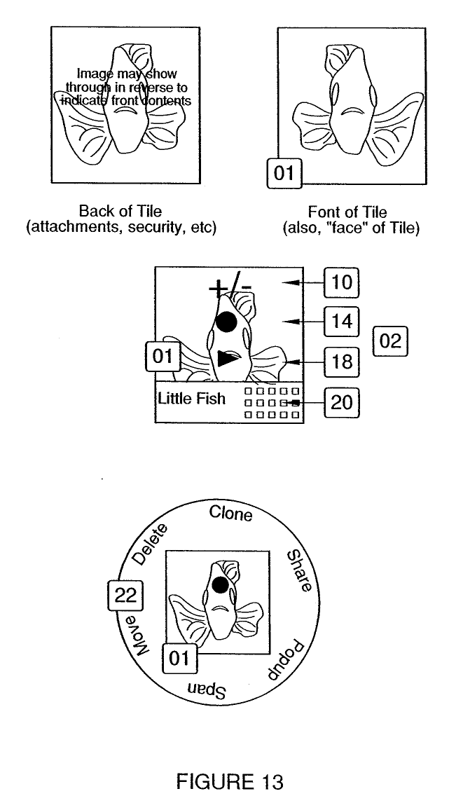

The present invention, in at least one embodiment, is a media package which may include metadata, content, links, methods, button/method associations, and sequencing information. This is described as a file format. From a technical point of view, the embodiment is akin to an object/series of objects in an object based programming model. From the end users point of view, this file format is experienced as a playable media file that is unique in the ways in which it may be associated, including with other files of the same type. This object is marketed under the name “Tilefile”™ and will be referred to as a “tilefile package” in the ensuing description. A tilefile package, to an end user, evokes the metaphor of a “tile” because the contents of the file type may be represented in a grid or other symmetrical pattern in a graphical user interface. That is, the graphical user interface, which will be described in more detail later, is composed of a plurality of viewing areas. Each of the viewing areas may hold representations of one or more tilefile packages. In other words, a viewing portion may display only one tilefile package, or may display a plurality of tilefile packages, in a grid or other pattern. To an end user, and for the purposes of this description, the term “Tile” will be used to denote a specific instance of a “tilefile package”, particularly a tilefile package when represented within a graphical user interface. The tilefile package, as represented in the user interface is divided into a “front of tile” portion and a “back of tile” portion (FIG. 13, (1)). The front of a tilefile package is also referred to as the “face” of the tilefile package.

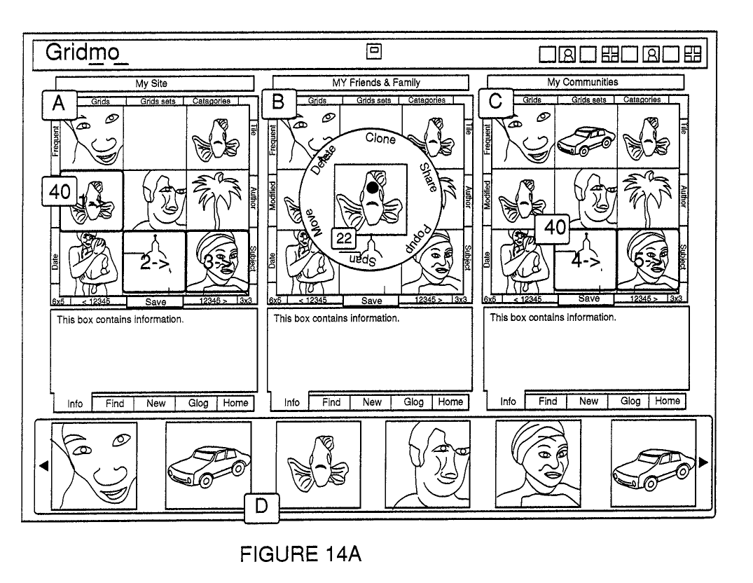

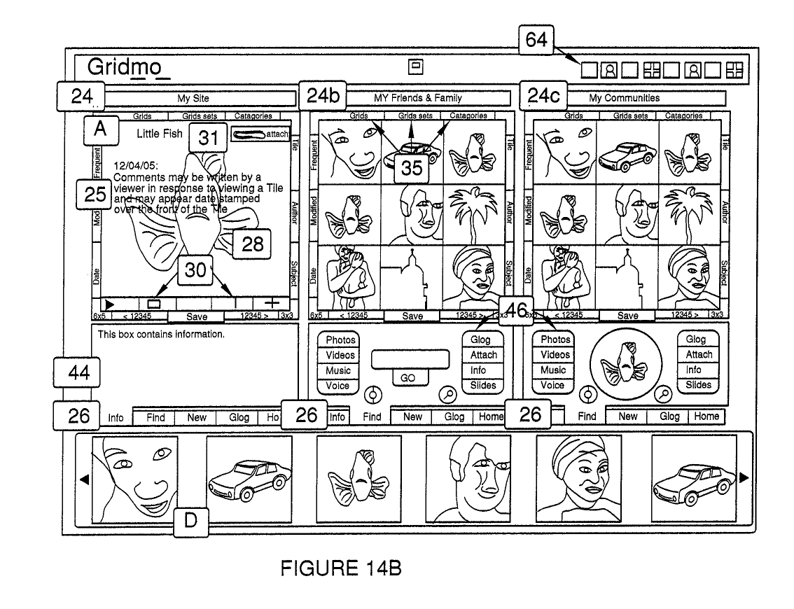

The face of a tilefile package, as immediately discernable to a user, is typically a photograph, video clip, or other visual representation of the contents of the tilefile package, and will generally be a representation of the “primary presentation element”. That is, the default visual element. In response to a user command, various functions are accessible from the front (or back) of tile (FIG. 14B, (30), these may include the adding and subtracting of additional presentation elements, changing the relationships between the elements, the logging of viewer comments in relation to the tilefile package (25), and the writing, editing and playing of a “script” that may be one of the assets of the tilefile package.

The various functions accessible from the front of the Tile are determined by the content of the Tile. That is, each viewing area is overlayed and or surrounded by a menu, the controls on the menu changing depending on the Tile displayed in the viewing area, and on other factors, such as whether a user is viewing the front of a tile or the back of a tile.

The back of a tilefile package, which becomes viewable in response to a user command (for example, clicking the button (31) in FIG. 14B), may allow an author to set preferences and properties, such as security, metadata, and search information, and also may allow for the adding and subtracting of additional elements, such as notes or any other asset. Viewers may be able to download attachments from the back of a Tile, however authoring buttons may not be visible to viewers who do not have authoring privileges.

Advanced functionality such as scripts may typically be accessed via the back of the Tile. Scripts may contain instructions, for viewing and interacting with the assets of the tilefile package, for interacting and coordinating with other associated tilefile packages, for executing external applications, and for accessing external non-managed data; such scripting gives advanced users access to the full power of the underlying operating system and network services. For example, a script may define an alternative presentation of the playable content of a tilefile package, it may translate spreadsheet data into an animated graph, it may call up a weather report or a live feed from a camera, or it may encapsulate one or more RSS feeds.

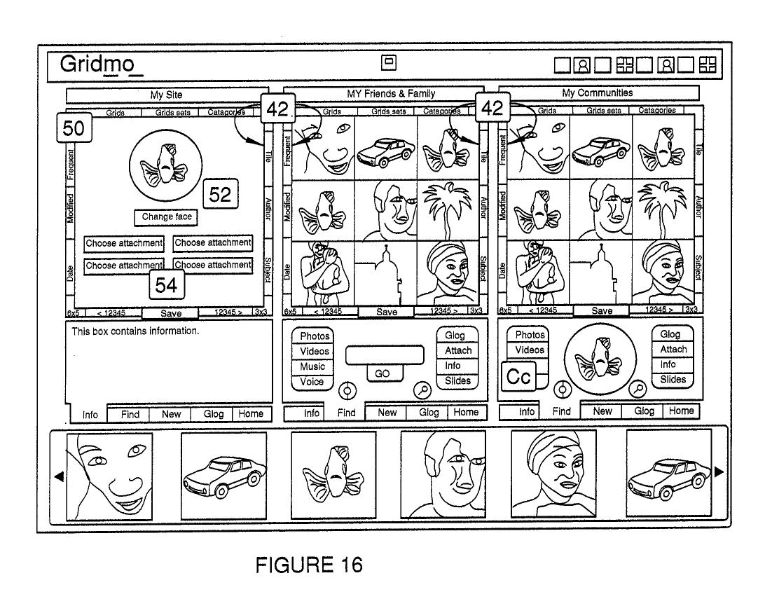

In the case where Tiles exist server side, a new Tile is automatically commenced when a user sends content from a mobile phone or device to their account. Alternatively, a user may author a new Tile by uploading content from their PC hard drive. In each Tile an editing window is provided to the author to facilitate upload of assets (FIG. 16, (50). This includes facility for uploading or changing the face of the Tile (52) and uploading or changing multiple attachments (54).

Each Tile behaves in the manner of a user interface “shell” and viewing multiple tiles in a pattern in the user interface is akin to viewing multiple user interface shells, where each Tile is has its own set of controls and “owns” its own content. As each Tile operates like a shell, it also determines the look, feel and functionality of the menu system that is associated with the Tile when the Tile is displayed in a viewing area. An instance of the menu system is part of the Tile and may always be proximal to it so that it is seen to belong to the Tile. This menu system may control any function associated with the Tile or the content of the Tile. This may include functions to manipulate the viewing of the Tile (e.g. displaying content in the tilefile package) or manipulating data within the tile (e.g. adding elements to the tilefile package, (50, 52, 54)). As distinct from an ad-hoc “pop-up” menu, the menu system of a tilefile package is always a recognisable instance of the tilefile package visual language, that is, it may be uniformly applied across all instances of tilefile packages in all contexts, including applications.

In other words, a tilefile package may be viewed as an active container which is capable not only of holding disparate forms of digital media, namely presentation elements, in a single entity, but also of providing the functionality to manipulate the content of the tiles, with the assistance of the graphical user interface. Every tilefile package is a unit that may be combined in a new form of visual literacy which relies on the unique advantages to the user of the uniform tilefile package interface.

As alluded to earlier, in the graphical user interface, the tilefile package may be grouped together into patterns and grids. TileFiles may also be linked together in a sequence (FIG. 14A, (40)), and an entire grid may in fact be a sequence where each row of the grid is the next portion of the sequence. Images such as photographs can be displayed on the face of the Tile, so that it is possible to glance at the contents of the tilefile package. It will be understood that in the description following, the term “content”, when referring to digital media, is equivalent to the term “presentation element”, and such terms will be used interchangeably. Other types of content relevant to these images can be stored within the TileFile, and content may be aggregated over time on a “per Tile” basis.

The metaphor of a “container” is useful for explaining a subset of characteristics of a tilefile package. However, like all metaphors, the container metaphor breaks down. For example, a crucial feature of tilefile packages is that a representation of the contents of the tilefile package may be made available even when the container is sealed. Furthermore, an individual tilefile package may have access to assets in other tilefile packages for the purposes of presentations. In this sense each tilefile package is also like a controller/sequencer.

Sequenced delivery (“playing”) of multiple media packages provides an alternative to conventional browsing. This may include a media package GUI acting as the front end of external applications. Groups of media packages may also operate as an intermediate layer on top of operating systems, forming a visual shell that is uniform across multiple applications and contexts.

tilefile packages may contain applications, or there may be communication through Tiles to applications. If the application is not embedded within the tilefile package, two main possibilities exist:
1) The tilefile package/GridMo system may automatically find and launch the correct application at either the client machine or the server machine by using the known file type associations (e.g. a word processor may be launched top open a .doc file).
2) A configuration may be embedded in the tilefile package, either by the author of the tilefile package or the author of the asset, to find the correct remote site and either
   a. Automatically download the corresponding application/plug-in and run it on the client side (and possibly delete it again after execution), or
   b. Execute the application server side to process the asset document remotely.

This latter feature means that end users may not need to be prompted to download and install an application or plug-in every time a new document type appears as an asset. It may also resolve the confusion when documents of different formats and used by different applications happen to have the same filename extension.

Tilefile packages may be used as “distributable terminals” of a videoconferencing system. In such a system each tilefile package serves two roles: Firstly it is a transferable file which contains or references the configuration for “hooking up” the videoconference participants. This may include starting the videoconference client application at the various client sites. It may also include invitation, scheduling, establishing the correct connections and logon. Secondly, the tilefile package becomes the GUI terminal of the videoconference client at individual client sites.

Tilefile packages may also be used as a layer for referencing and managing 3^{rd} party content, including federated content. In these contexts, tilefile packages offer a solution to Single Sign On issues (SSO). Where a user has multiple username/password pairs for different systems, a single tilefile package can be used to fetch and encrypt multiple username/password pairs, managing the logon to multiple systems as required.

Tilefile Package Structure

The structure of the tilefile package includes static properties (such as the image displayed on the front of the Tile, author/owner details, etc.) and dynamic properties (media files contained within the TileFile, a list of relationships to other tilefile packages, commands which determine the look, feel and functionality of the menus which appear etc.) as its attributes, and with a presentation action and or sequence as its method (function). In the implementation described herein, static properties are generally kept in a header section, and dynamic properties are kept in a binary information store. However, these categories are not rigid. For example, the bi-directional link is contained in the header, even though it is a dynamic property. Similarly, when content is modified, the size information in the header will may also be modified.

The tilefile package may be thought of logically as a self-contained entity, and so the tilefile package, through the graphical user interface, is also presented to the user as a self-contained entity, or a subset of the tilefile package may be presented. In either case, as stated, the structure of a tilefile package is divided into two distinct sections, the header section and the media or assets (binary information store) section.

The header section includes a listing of general properties such as the format version (for backwards compatibility), the owner/author details, pointers to the face of the Tile (facilitating progressive download on a single image file to extract a preview image, and multiple different levels of display resolution), privileges such as those pertaining to reading, downloading, executing and editing of the tilefile package, and asset properties such as an index of assets and relations.

The assets index includes details of each media file or other asset contained in the tilefile package. These details include: Name, Type, Last Modified, Privileges, Size, Offset position in the Media section, and the download status. In the full instance of a tilefile package, the combination of size and offset may be used to locate the media file binary in the media section, and to extract it for presentation.

In one embodiment, to reduce download times, a tilefile package is not downloaded to the client machine at once. Only the header is downloaded initially. A media binary file is only downloaded when it is needed, or when there is sufficient bandwidth available for this to take place without disrupting the user (background downloading). In the case of background downloading to a partial instance, a download status will be recorded identifying the break/resume points of downloading media files to a partial instance of a tilefile package.

The tilefile package may also include a bi-directional link. The bi-directional link is a link to another tilefile package and or to content in another tilefile package which is either “used by” or “using” the current tilefile package. The bi-directional link is akin to a double entry accounting system, in that the formation of a link from one tilefile package to another will be balanced by a corresponding relation pointing back to the tilefile package from which the link was initially made. This makes possible the instantiation of a decentralised abstract database. The idea is that regardless of the physical location of a tilefile package, the bi-directional links permit the system to track the Tiles. This makes Tiles mobile. Each tilefile package exhibits a high degree of autonomy, but any one tilefile package “knows” its relations and this knowledge may be used to call upon groupings and or sequences of other tilefile packages.

When creating a duplicated copy of a tilefile package, the media files in the original need not initially be copied into the duplicate (partial instance), rather they may be marked in the duplicate (partial instance) as a “copy relation” (i.e, an actual physical copy of individual media files need only be created when the media file in either the original tilefile package or the copy tilefile package is modified). This approach can significantly reduce the consumption of resources. Similarly, a copy of a tilefile package that is “used by” a high number of other tilefile packages may not include the “used by” links, but may access these links via a relation to the original. There may also be a subsidiary store for this information that may be referred to as a “link companion” to the original and or the copy.

When a tilefile package which has links with other tilefile packages is moved or removed, it is not necessary to update all linked tilefile packages immediately. Instead, a “dummy” tilefile package may be inserted in the location of the moved or modified tilefile package with the purpose of redirecting any “using” links to the new location. When the moved or modified tilefile package is visited by a tilefile package with which it has relations, the dummy instructs the visiting tilefile package to update itself. When all the related tilefile packages have been updated, the dummy tilefile package may be automatically deleted.

A dummy tilefile package, or a variant, may additionally serve the purpose of retaining the “used by” links of the tilefile package copied or moved to the new location. The tilefile package in the new location need only update its used by links as the “using” tilefile packages are redirected to the new location by the dummy. In this way copies may evolve away from their original, without losing the potential of reacquiring the relationships and or history of the original.

Figures

Referring now to the figures, at FIG. 1 there is shown a basic structure of a tilefile package and its relationship to the Graphical User Interface (GUI). A tilefile package is comprised of a header that is text, a file body which contains assets in their native binary form, and a textual information store which may also be a binary file or may be stored in some other form. The file body may also contain one or more scripts,that is, instructions that may be run or played.

In more detail, the sections are:

(i) A basic header which is text formatted and contains the name of the tile, a description of the tile, the author (and/or the user account the Tile is associated with), a date and time stamp, and a version number.

(ii) A header relationship stored as bi-directional links, containing a flag which states whether the tilefile package is “using” or “being used by” the various groupings of tilefile packages of which it is a member (see also FIG. 1a).The use of bi-directional links allow every Tile to “know” and “remember” which groupings of tilefile packages it is associated with, and therefore how to assemble its own contents and the contents of other tilefile packages into a meaningful presentation.

Because every tilefile package has a “face” (the “front” of tile), and these faces may represent video clips and other time based presentations (including still images presented for a specified time duration), a sequence of tilefile packages can form a time-based presentation by displaying one face element after another. At any time the user may pause the presentation and drill down into the contents of the specific container whose face is currently on display.

(iii) Header Binary Information Pointer(s)/Assets Index. Byte part strings are stored here describing how the file separates binaries, along with the form of the binary.

In more detail:

1. Binary Information Store

This is where media content is stored. By storing the binary information in its native form, multiple file formats may be supported. Manipulation of the data does not necessarily take place in the TileFile, rather it may be extracted, manipulated, and returned such that it either appends the previous version, or overwrites material of a prior date, or both. Multiple iterations of binary information may be stored so that a history of modifications can be retained.

2. The File Body Contains, as a Special Category, the “Face” of a Tile

This is the front of the Tile as displayed in a GUI. This element may be sequenced with the faces of other tilefile packages. The Face of Tiles may also be stored in a preview form for quick loading, or they may progressively download, increasing their resolution in the GUI over time. The faces of multiple tiles may be sequenced to present one after the other as a single presentation. If the face is a still image, it may present for a given time duration, as in a slide show. If it is a video clip, it may present from a specified in to out point. In this way still images and video clips (and other time-based media) may each form sub-clips of a sequence that has a given time duration.

3. Text Based Assets

Used primarily for the recording of logged comments relating to the individual tilefile package, or a grouping of tilefile packages of which it is a part. This may be an XML based database incorporated into the file itself. Alternatively, each comment may be logged into the tilefile package as an asset of the tilefile package. Text may be stored in binary form, or in some other form.

Referring to FIG. 2, one of the chief limitations of an HTML webpage is that it is not a container, and is trapped in its original context by URL linkages. Primarily a text format storing all data contained as text, HTML has been adapted to accept any format of file, however it is not a storage device, merely a linking device. If HTML files are moved from their original context, the content to which they are linked will not display unless it is moved with the HTML file.

A tilefile package is more readily able to roam between contexts because it contains the primary and further presentation elements, and also may retain all linkages in the header (or at least be able to find its store of linkages), therefore knowing which other tilefile packages it “uses” and which other tilefile packages “use” it. In special cases where all linkages are not stored in the header, the tilefile package may be updated with these linkages on an as needs basis, or may access them remotely.

Referring to FIG. 3, there is shown a representation of how bi-directional links operate.

tilefile packages may reference other tilefile packages through the formation of bi-directional links. A tilefile package is either “using” another tilefile package, or being “used” by it. This means a tilefile package potentially “knows” all the groupings of which it is a part, and also knows its place in the sequence or hierarchy of each grouping.

Referring back to FIG. 1a, bi-directional links also facilitate the sharing of media files for the purposes of presentations. A tilefile package may have zero or more bi-directional links to other tilefile packages.

Each link describes:

(1). Link Type—“Using” (primary link) or “Used by” (secondary link) the tilefile package at the other end of the Link. In other words, in a situation where a tilefile package is linked to another tilefile package, the original link is the primary link, and the link from the another tilefile package back to the original tilefile package is the secondary link. This establishes an order in which the links operate, so each tilefile package is aware of it's location in a hierarchy of tilefile packages;

(2). Path—The name and path (whenever necessary) of the tilefile package at the other end of the Link; and

(3). An optional list of assets to be used. In the case of “Using”, the list refers to the assets of other tilefile packages. In the case of “Used by”, the list refers to assets of the current tilefile package. When the list is empty or is not specified, then by default the face image of the “used” tilefile package is assumed to be the (only) used asset.

Referring to FIG. 4, there is shown a diagrammatic example of how the tilefile package references media locations in the binary file. The arrows point from values stored in the header, to the actual location in the binary file.

FIG. 5 illustrates how the tilefile package references media content for the face of the tilefile package. The face, or an optimised version of the face, is available for quick download, so that the tilefile package may be quickly represented in the GUI. Larger assets may be set to download progressively in the background.

tilefile packages may be segmented into smaller sections for more manageable download. Values in the header (local header on the client machine) point to actual locations in the binary file.

Referring to FIG. 6, a further problem of the HTML page is that even if a page is successfully transplanted with all assets to a new context, any other pages and sites which were previously linked to the page may become dead ends, broken links. However in a network of tilefile packages, it is almost always possible for one tilefile package to relocate those tilefile packages which it “uses” even if those tilefile packages have changed location or context. This is achieved through the use of the bi-directional link.

Referring to FIG. 6b, because tilefile packages are linked bi-directionally, the relationships survive changes of location, and are location independent, as illustrated by the following examples.

Referring to FIG. 7, a grouping of tilefile packages copied to a new site will run locally, as they are each self-contained entities who know their relationships.

Referring to FIG. 7b, if a single tilefile package (or a subset of a larger) grouping of tilefile packages is moved from one site to another it may still access and “use” its relations remotely.

Referring to FIG. 8, it is shown that tilefile packages may also be ascribed with different functions, which may also be termed subclasses. FIG. 8 illustrates four potential subclasses of tilefile package:

(i) The Media Tilefile Package

This is the basic container.

(ii) The Menu Tilefile Package

A menu tilefile package is normally empty, except for the face. The Menu tilefile package allows for Tiles to be organised into “grids of grids”. A Menu tilefile package may appear alongside Media tilefile packages in a grid or pattern. However, the Menu tilefile package, if selected, will open a sub grouping of Media tilefile packages, or a sub grouping of further Menu tilefile packages, until eventually Media tilefile packages are reached.

A Menu tilefile package also has the capacity to command an entire grid of Media tilefile packages to be replaced by a large single image (normally the image on the face of the Menu tilefile package), either momentarily, or for an extended period, or as a default setting. Menu tilefile packages may also be used to set properties of tilefile package applications, and to change the “skin” (including appearance and layout) of whole interfaces. In this way, one user may share a Menu tilefile package with another user, so that that tilefile package modifies, sets or resets preferences and or appearances of the other user's application GUI.

(iii) The Media+Menu Tilefile Package

This is a hybrid of a Media tilefile package and a Menu tilefile package, where the file functions as a menu item, but also functions as a container in its own right. Whereas a Menu tilefile package is normally empty except for the face and relations, a Media+Menu tilefile package can be filled as any Media tilefile package can be filled.

(iv) The “Dummy” Tilefile Package

The Dummy tilefile package exists to protect and re-establish bi-directional links. Moving tilefile packages to new locations within the hierarchy of a site poses a different problem. The relations remain the same, however the location has changed. FIGS. 9a-e illustrate a simple solution. In 9a, a move of location takes place. FIG. 9b illustrates the problem—the bi-directional link is potentially broken. FIG. 9c illustrates the solution: A dummy tilefile package is automatically inserted as a “middleman” who instantly points the way to the new location. Then, over time, a maintenance procedure may redirect all links to the new pairing of locations. This having been achieved, the dummy tilefile package may be automatically deleted (9d). FIG. 9e illustrates that the status quo (as per 9a) has been restored.

As shown in FIG. 10, a tilefile package can contain and/or can be programmed to contain a presentation which includes and/or sequences the media files that the tilefile package carries (assets) or knows (Links). As the file type evolves, it will eventually offer presentations with multi-track capability (see FIG. 10a). The sequencing of multiple faces (fronts of tile) into slide shows and multi-clip video presentations (and any mixture of the two) is a simple subset of the presentation capability (see FIG. 10b).

The Graphical User Interface

The tilefile package embodiment of the media package is designed to be implemented across and within multiple applications such that the tilefile package Graphical User Interface remains recognizable irrespective of the content of the tilefile packages displayed, the operating system utilised, or the referencing of third party content. Both individually and collectively, tilefile packages may form a visually uniform “shell” that behaves as a portable cross-platform operating system. Referring to FIG. 12, multiple tilefile packages may each be represented by a single image in various panels (A, B, C, D) in a user interface. In the interface, actions upon the representative images (“Tiles” or “faces” of tilefile packages) mediate actions upon the media packages (tilefile packages) as a whole. For example, more than one media package may be grouped or linked by grouping or linking the representative images within the user interface (FIG. 14A, Numeral 40)). That is, grouping or linking of the representative images (faces) at the level of the user interface results in the grouping of the referenced or contained information between the physical files (including both the physical container and logical container forms of the tilefile package).

The representative images may be grouped as a matrix in a grid-like pattern, or as some other grouping, cluster or tableau of multiple images. By migrating images in the user interface, it is possible to migrate packages to a new position within a grouping of packages, to a new position in a sequence, or from one grouping to another grouping, and or from one sequence to another. This generates new inter-relationships between the packages and their constituent elements.

Changing the relationships between media packages is achieved through the tilefile package User Interface.

There is provided a “face” to a tilefile package. The face is a visual element that serves as the icon or thumbnail representation of the tilefile package. The face also represents that element to which the tilefile package may default in presentation sequences i.e. unless otherwise nominated, the default presentation element is the element represented by the “face” of the tilefile package.

At least a subset of the buttons have standard behaviours, for example a button to reveal the “back of tile” region (FIG. 14B, Numeral 31), or other non-face views of the tilefile package (30), providing access to secondary elements such as attachments, security preferences, and also providing access to secondary processes such as presentation editing (FIG. 16, (50)), or a scripting language by which tilefile package presentations and or methods and or functions and or behaviours may be modified by the user.

FIG. 13 illustrates a graphical user interface for TileFiles. Numeral 01 denotes the face of a tilefile package (“Front of Tile”). When any one of the four horizontal sectors (02) of the face of the Tile are moused over, one of four horizontal bars appear, each bar being a button for mediating a different function. The order in which these bars are arranged is subjective, and may be selectable by the user as a user setting or preference.

In the example in FIG. 13 (02), the bottom bar (20) is a title bar that reveals a text title associated with the Tile. It is also a drag bar. That is, when the mouse is over all or a portion of this region, the entire Tile may be dragged from one context (e.g. a grid in one panel A,B, C or D (FIG. 12)) and associated into another context (eg a grid in a different panel A B C or D).

The second bar from the bottom is the “play” bar (18). Clicking the mouse when mousing over this bar results in the Tile being enlarged for viewing, and if there is a time dimension to the face (e.g. a videoclip to be played from a beginning point to an end point), the enlarged Tile begins to present its time based content.

Similarly, if a sequence of faces have been selected to play in sequence (FIG. 14A, numeral 40), the play bar may be selected on any one of the Tiles in that sequence, and the sequence will commence playing from that Tile forward. During playback, at least the faces of these Tiles are edited together as a form of slide show, or hybrid slide plus video (or other time base media or web content, eg RSS feeds) show). For example, still images such as photographs or slides may be exhibited for a default time duration of say 3 seconds during playback. Display of this Tile sequence may occur in a window which enlarges so as to temporarily occlude the underlying grid (FIG. 13, #08). An entire Grid may also be played as a sequence.

The third bar from the bottom is the “circle menu” control (FIG. 13 Numeral 14). Clicking on this bar results in the circle menu being displayed around the face of the Tile (FIG. 13 Numeral 22).

The bars primarily control how the Tile (face or back) is represented (for example its relative display size in the interface, whereas the circle menu primarily controls editing of the content of the media package as a whole. In this example, the circle menu offers buttons for cloning the entire package, sharing the package, opening at least the face of the package in a separate pop up window (this function may alternatively be mediated by the bars, as it is not strictly a whole package function), conducting a special search of which presentations the tilefile package has been sequenced within (a “span” search), moving the entire package from one context to another, or deleting the entire package.

The fourth bar from the bottom, that is, the top bar (FIG. 13 Numeral 10), is a button for enlarging the Tile up out of its context in a grid (or other context), to a size capable of displaying finer grained options for authoring, viewing, manipulating or contributing to a tilefile package (buttons for these finer grain options are shown in FIG. 14B at Numerals 30 and 31). This functionality is represented by a +/− symbol, that is, it enlarges the Tile when small, and reduces it again when it is already large.

Tilefile packages may include multiple file types and codecs to simplify and amplify the user experience of disparate content and they may also sequence and organise disparate forms of objects and content, presenting this content in grids and sequences where, at a user interface level, essentially the same type of user interface is presented to the user, regardless of what is going on “behind the scenes”.

The user interface, while finding particular application with the media package previously described, may also be utilised across multiple applications and as a universal front end to various 3^{rd} party databases, datastores, or layers of federated content. In the proceeding description, reference will be made to a “surface” tilefile package and a “depth” tilefile package. These terms are coined to describe the user interface when it is used to display and manage third party content (a “surface” tilefile package, since the tilefile package is not holding content per se, but merely acting as a conduit to the content) and a “depth” tilefile package, where the tilefile package is displaying and managing the media package described herein.

For the end user, regardless of the content of the tilefile package, each face of the tilefile package provides an access point to whatever content has been aggregated or referenced to that face, and a familiar set of buttons exhibit standard behaviours and allow access to the other parts of the tilefile package, in its familiar organization of content and methods etc.

The tilefile package Graphical User Interface is, in effect, designed to provide a common user interface with common controls and predictable behaviour, irrespective of the file types contained within each media package and/or third party information store. That is, the Graphical User Interface forms a unit of “visual literacy” consistent across all tilefile packages, and therefore across multiple applications and contexts.

Tilefile packages may include applications amongst their secondary elements and a script may be made available to users to code user defined forms of tilefile packages with their own unique behaviours and qualities, including the ability to “call in” content and specific display methods or properties.

Tilefile packages have the means to contain and aggregate a growing number of disparate elements and also the means to modify the relationship between these elements.

Furthermore, constituent elements may be received into a tilefile package from multiple sources, including mobile phones and desktop PC's. In this way each tile forms an integrative hub between the Internet and the mobile networks.

Each tilefile package is normally represented as a single image (image in this context is defined as inclusive of photographs, video clips, animations, graphical elements, icons and portions of text). Via the manipulation of these representative images, entire tilefile packages may be grouped or linked via the grouping or linking of the representative images. Unlike grouping files in a folder, or folders in a folder, the grouping of tilefile packages into a pattern such as a grid results in a plurality of images that may be displayed in a tableau (such as a grid of images or fragments of images) in which the whole picture may provide information and generate meaning that is greater than the sum of its individual parts or pictures.

Identifying increasingly complex relationships between tilefile packages become possible due to the fact that each representative image represents solely its constituent assets, while at the same time being presented in relationship with other representative elements in a tableau, such as a grid.

These images therefore have a dual function. At the level of the grid or tableau, they combine to form visual inter relationships between the representative elements. They also serve as markers to a grouping of information assets, so that when a user selects an individual image from the tableau, they are presented not merely with a compilation of files and folders, but a graphical user interface in which the relationship between constituent assets in the package (tilefile package) may be modified from multiple sources and devices, and where the constituent assets may include or reference applications.

Contained or centralized applications may be marketed as content (“a tilefile package”) rather than as a service. This has commercial advantages, where the consumer may respond more readily to content (e.g. the provision of a movie or a song) than to a service (e.g. a website arranged to categorise and hold songs). In other words, as with multiple codecs, through a tilefile package, multiple services may be provided to the user without any special knowledge on the part of the user. This simplifies the provider to user/consumer relationship.

Furthermore, the tilefile package may function not only as an information managements system and content aggregation system, but also as a micro presentation in the larger presentation context of the tableau, such as a grid of tilefile packages. Any individual tilefile package may contain or reference a presentation including elements of other tilefile packages. The default form of this presentation is a sequence of tilefile package faces. This provides an alternative to web “browsing”. Instead of browsing many pages of information, grids of tilefile packages may be organised to reference updating information (likewise the update of content contained in a tilefile package may propogate to any presentations of which that tilefile package is a part). Similarly, RSS feeds may be referenced by or incorporated into tilefile packages.

For example, one Tile in a Grid may be an updating news report, the next may be a weather report, the next may be a new movie review, the next may be sports highlights, and the next several tilefile packages may be messages from friends. By playing the entire Grid as a sequence each morning, a viewer may be presented with all information that is relevant to them, rather than having to “browse” the information across a number of different websites. In other words, the Graphical User Interface provides a powerful solution to traditional convergence problems, including not only the convergence of media types, but also of the Internet with more traditional media such as Newspapers, Television and Radio.

The visual and intuitive identification of increasingly complex relationships between different content becomes possible since each representative image represents solely its constituent assets, while at the same time being presented in relationship to other representative elements in a pattern such as a grid, such that the representative elements images form a meaningful tableau that may be greater than the sum of its primary elements.

The TileFiles available to a user may be visualised as a collection of individual tilefile packages, in the form of a flat grid made up of the faces of every tilefile package accessible by the user. The faces provide an entry point to the other elements or methods contained or referenced by the TileFile, which may include sequence relationships to other TileFiles or data, presentation data, media, scripts and applications etc.

Searching Content

To find any given tilefile package or group of related tilefile packages, search filters are used to narrow the entire grouping to a narrower grouping, until a viewable subset of Tiles is finally achieved. In FIG. 14b, the halos of menus (42) around the grids include buttons for narrowing the search to the most recent Tiles, the most recently modified Tiles, or ordering the Tiles by title or author or the most frequently used, etc. Similarly, the search panels at (46) permit narrowing the subset to only those faces which are videos, or those which are photos, etc. A search term may also be entered, and the search narrowed according to which criteria this search term is intended to apply to. From the viewable subset which is returned, a viewer may then explore the relationship knowledge contained in or associated with any one tile, the user working their way back out from this tilefile package to the other tilefile packages to which it is specifically related, for example as part of a presentation sequence.

However, users may be provided with an account, which they may customise by arranging tilefile packages within a grid structure, and even grids of tilefile packages within grids.

Since a tilefile package account is essentially one flat grid of searchable Tiles, the organization of these Tiles into category-based sub-grids may be mediated by Menu tilefile packages which contain the knowledge of their relationships to other tilefile packages, but need not actually contain the other tilefile packages. Therefore deleting a Menu tilefile package (e.g. a grid of grids) need not result in the deletion of the tilefile packages referenced by this Menu tilefile package. This is one of the advantages of a presentation model where tilefile packages contain (logically and or physically) the knowledge of their relationships, for example via bi-directional links.

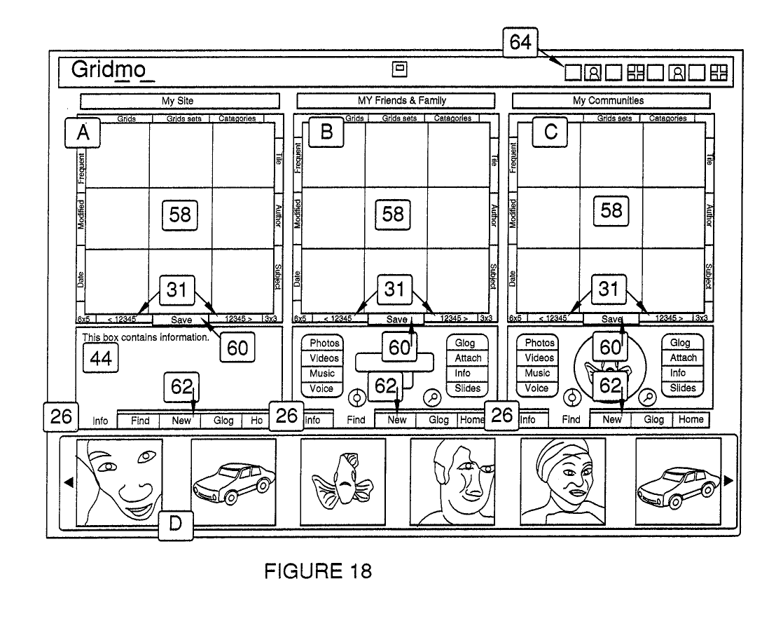

The graphical user interface may itself be fully or partially defined by one or more menu tilefile packages, that is, a tilefile package which references all the tilefile packages it is capable of displaying. In this way multiple different layouts of the interface may be implemented as multiple different Menu tilefile packages, which may be shared. For example, if one “power user” creates an alternative layout for the GridMo interface, that person may share their unique layout with the whole GridMo community by sharing with them the Menu tilefile package(s) which define their uniquely organized interface. This is illustrated in FIG. 18 at (64). By dragging an appropriate Tile into a position in the header bar of this interface, changes may be applied. Similarly, help files and other instructional material may be mediated by tilefile packages. A help tilefile package may even contain a script that runs to identify issues and to report on and possibly even repair problems.

Interface animation and menu tilefile packages may be used to create the interface illusion of advancing (“flying” “tracking” or “zooming”) deeper (or shallower) into grids of grids of grids. However, a simpler form of the same concept may be applied as menu tabs referring to three primary layers. This may be used to familiarise users with the concepts necessary to effectively interact and manipulate TileFiles and also to maximise resource efficiency where high speed internet connections are not available.

The system of tabs is divided into one or more “panels”, and each panel has at least three grid layers. (see FIG. 14b, Numerals 24, 24b, 24c)) The “deepest” grid is dubbed “categories” (grids of grids of grids), the middle layer is dubbed “GridSets” (grids of grids, where each grid of grids is visually represented by the face of the first tilefile package in the grid—in other words, a grid of grids is literally a grid of the first faces of all the subsidiary grids) and the surface layer is dubbed “Grids” (or simply “Tiles”) (a group of tilefile packages sequenced into and displayed as a grid of tilefile package faces).

By the use of this interface concept, which may be mediated by a Menu tilefile package, very large numbers of tilefile packages may be searched and navigated in a single panel.

For example, if every grid matrix is limited to 36 tilefile packages (i.e. a 6×6 grid), a full panel may reference 36×36×36=46,656 tilefile packages.

Furthermore, scrolling grids may be provided. Therefore, a single panel may reference very large numbers of tilefile packages. Furthermore, there is no reason why a panel needs to be limited to three layers. However, three panels may be a pragmatic limit, beyond which navigation becomes more cumbersome and less intuitive.

Multiple panels may then be organised into a simple list of panels, dubbed a “library”.

It is also possible for a panel to include a hybrid version of a grid, such as a grid which contains both Tiles, Grids and Grids of Grids, all at a single layer. In this case each image in the grid may need to be marked to indicate what type of tilefile package it is (i.e. an ordinary tilefile package, a Grid, a Grid of Grids, etc). This type of more arbitrary, ad hoc grid is dubbed a “clump”.

A panel may also include a special category of tilefile package sequence dubbed a “span”, suitable for a quick preview of a tilefile package in a partial context. FIG. 12 Numeral 38 shows three spans.

Spans may be generated through a specific new category and type of search (a span or “spanner” search), where a specific tilefile package is searched to establish which several of multiple presentations it is part of. The “spanner” panel is illustrated in FIG. 12, Numeral 36. Span results facilitate a quick preview (spans at 38) of the immediate sequential context of the spanned tilefile package (at 36), without requiring the loading or previewing of the entire grid of which the span is a subsequence.

This is both resource efficient, and time efficient for the searcher, who may only need a quick indication of context in order to the relevancy of a particular presentation sequence.

A span result consists of a sequence of at least 3 tilefile packages (FIG. 12, Numeral 38), where the central tilefile package in each sequence is always identical and is displayed in the spanner panel, 36 The preceding and subsequent tilefile package in the span results (38) facilitate the viewing of multiple micro-contexts of the central tilefile package.

The central face need not be repeatedly represented. A span may be represented as three tilefile packages but actually consist of four tilefile packages. The first Tile in the Span may be the first Tile in the grid of which the Span is a sub-sequence. The second Tile in the Span is then the tilefile package preceding the Tile which the Span spans, and the third tilefile package in the Span is the tilefile package subsequent to the tilefile package which the Span spans.

FIG. 12 illustrates this concept at (38), where the second and third Tiles are linked to indicate that they span a given face. Of course, more preceding and subsequent tilefile packages may also potentially be displayed, widening the context of that tilefile package (36) which is the subject of the Span search.

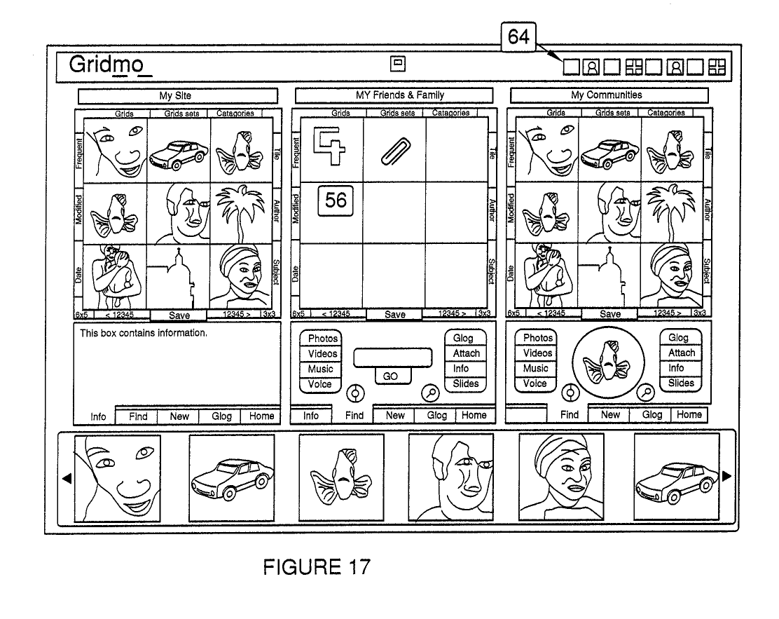

A panel may also include a grid of tools represented by icons FIG. 17, numeral 56). Dragging a tool on top of another face (or vice versa) results in a specific action or process being applied to that tilefile package. These tools may be icons, or they may be actual tilefile packages. In this way the graphical user interface has the potential to form an interface to any number of existing applications or stores of information, where all processes are mediated by “Tile on Tile actions”.

For example, in an audio editing application, one tilefile package may reference or contain an audio file, and another Tile in a grid of tools may reference or contain an audio filtration algorithm. By dragging the filtration algorithm tilefile package onto the audio file Tile (or vice versa), a new Tile may be created containing the filtered audio file. This may be displayed in a “results” grid.

One of the fundamental advantages of organising content into tilefile packages is that the “face” of the tilefile packages provides a form of visual literacy that includes the sequencing of both still (eg photographs) and moving (eg video clips) into hybrid presentations. Sequencing multiple faces allows a sequence based presentation.

Moreover, the user is able to “drill down” to the other content that has and continues to be aggregated with that face. In this way tilefile packages provide a common system for the aggregation and exchange of context related information that is provided in a number of different formats.

For example, in any tilefile package a viewer may be able to log comments pertinent to the face or content of that tilefile package. This is similar to Blogging, however due to the grid organization of Tiles, it is dubbed as “Glogging”.

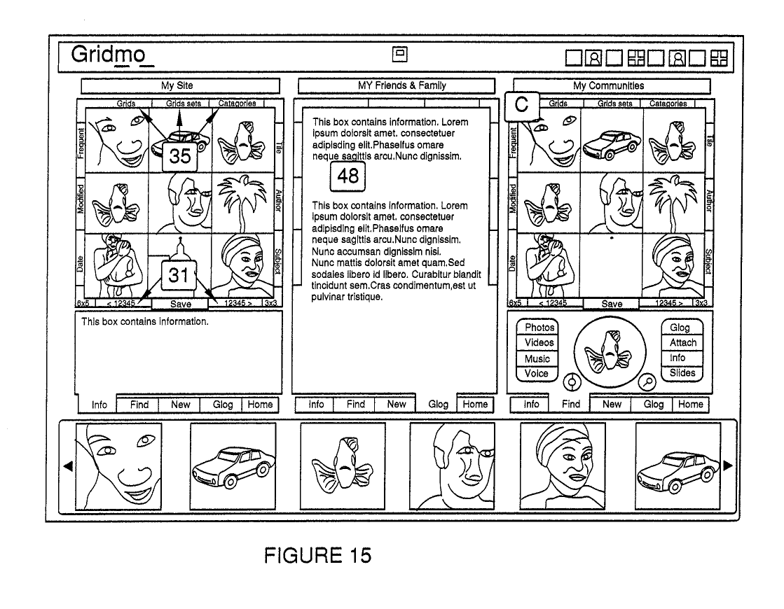

In a more sophisticated example, a user (or the system) may assemble or compile all the glogged comments from all the tilefile packages in their account (or a subset of all the tilefile packages in their account) into a new Tilefile. This is identifiable as a traditional Blog (FIG. 15, Numeral 48), except that strings of comments are always contained in their relevant tilefile packages, and therefore an entire string of comments may be moved or copied from one context or grouping of tilefile packages to another context. Furthermore, because strings of comments are contained in Tiles (logically or physically), the compiled Blog (Glog) may be ordered according to whatever criteria the tilefile packages permit (eg date, author, subject, etc). Comments added to this compiled view are added into the appropriate tilefile package, and may therefore be added at any level of the compiled entries (rather than simply at the top or bottom).

Therefore, while a Glog can be viewed as a conventional list of comments, it also has a non-linear, non-enmeshed quality, where entire groupings of comments may be accessed, searched or re-tasked, and where the reader of any comment may elect to view the tilefile package that contains or references the comment, thereby accessing all other content which is associated with the comment.

Another advantage of the TileFile to the user is that the tilefile package potentially makes a whole plethora of media types (including proprietary file types and codecs) invisible to the user, sparing them the inconvenience of dealing with each and every one of these ever-proliferating types. From the users point of view, the presentation is simply a tilefile package. Behind the scenes, the tilefile package manages or mediates all containing, referencing, trans-coding or otherwise interpreting and presenting content in a uniform and familiar way. By placing the graphical user interface in front of whatever it contains and/or references, uniformity is introduced. This unifying principle simplifies and streamlines media convergence, relieving the ordinary user from having to participate in overly complex processes. This advantageously allows the user to focus on content rather than process.

FIGS. 12 to 19 are different views of a preferred layout for a graphical user interface, as seen within a browser window. In each of these figures, different elements of the interface are active, for the purpose of describing the main features of the interface.

The interface may comprise of 3 main panels (A,B,C) organised into grids of tilefile packages (A,B,C in FIG. 12). Each of these panels has a sub-panel beneath it (Aa, Bb, Cc), where in addition to Tiles, text information and tools such as timelines and search filters may be displayed. Text information in these panels may in fact be a preview of information contained within a selected Tile or grid. There may be a fourth panel of tilefile packages organised as a row of Tiles (D). The fourth panel may be used as a “holding bay” for new content that has been received from mobile devices, and which may require further allocation. It may also be used as a history of recently viewed tiles, or to access and display various other content, such as library content, “favourite” tiles, or simply to enlarge an entire row of any grid that may appear in panel A, B, or C. It may also be used as a timeline, a sequence line, or an additional text window.

Any tile may be dragged and dropped into the dock in alias form, so that this tile may be dragged back into one or more alternative contexts from the dock.

In a centralised service, the dock at D, or any Tile position, may be used for a new form of “Tile” advertising, where tilefile packages contain advertisements which may utilise any or all of the capabilities of tilefile packages, including their capacity to contain scripts and applications (eg games).

While the four panel arrangement has advantages over a single panel, especially for file sharing, messaging, and grouping subsets of tiles, the functionality described forthwith may in fact, through the use of an additional or alternative menu system, be achieved with the use of a single panel, which may be more suitable to small display screens, such as those found on mobile phones, PDA's, small notebook computers, or perhaps even on a device such as an iPod™ or some other mobile multimedia player. In these devices a system such as tabs may make it possible to move between multiple panels, only one panel being displayed on the screen at a time. Alternatively, it may be possible to advance or “fly” into layers such as grids of grids of grids, ad infinitum.

In the interface illustrated in FIGS. 12 to 19, Panel A normally displays the latest tilefile packages belonging to the user of that individual site (user “A” “My Tiles”). Panel B normally displays the latest tilefile packages belonging to Friends and Family, and Panel C normally displays the latest tilefile packages of the users various “Communities”, such as workgroups, forums, or subscription services such as news, music, or movie reviews. In this way, a single interface may simultaneously access more than one user's set of Tiles (eg panels A, B and C simultaneously). This is a superior approach to conventional Blogging and Sharing Sites not only because it is built out of tilefile packages, but also because the graphical user interface displays the user's tilefile packages in the context specific categories, widening from Family, to Friends, to Communities. In a single screen, the user may share, re-contextualise and re-task meaningful subgroups of information.

Returning to the concept of a panel comprising at least three layers the top left Tile position of the deep “Categories” layer may be labelled “All Grids”, meaning that if this Tile is selected, the middle “GridSets” panel will display the entire collection of grids in the given panel. For example, a 3×3 or 6×6 matrix will then display the latest 9 or 36 grids, and the user may click the buttons at (31) (FIG. 12) in order to advance to the next set of 9 or 36 Grids (or scroll to the next line). If any one of these grids in the GridSets layer is then selected, the surface Tiles layer will then display that subset of the Tiles of the selected grid which the matrix size permits.

The default organization of Grids, GridSets (Grids of Grids) or Categories (Grids of Grids of Grids) may be by date, with from newest to oldest, or vice versa. However the side menus in the “Halo Menu” which surrounds the panel (42) may be used to filter and reorder the display of the tilefile packages at any of the three layers, for example, by title, date modified, most frequently viewed, author, subject, etc.

Similarly, any other category may begin the journey up through the layers, so that the deep categories layer forms an initial system or user define-able point of entry or filter into the collection of Tiles as a whole. Other Categories and or GridSets may include “Family”, “Work”, “Members” “My Public tilefile packages”, “My Private tilefile packages”, “Movie Reviews”, “News Stories”, “Friends”, “Holidays in Japan”, etc. At any layer there may be a Master Tile which contains all content for that layer. Selecting the master Tile on deeper layers effectively by passes that layer (for example selecting “All Grids” at the Categories layer means that the Categories layer has effectively been bypassed, and all Grid material is available at the next layer up.

The tabs at 35 may read differently, depending on what is selected. For example, instead of the generic “Categories, GridSets, Tiles”, The tabs may read “Family”, “Yukiko”, “Yukiko in Sydney”, giving the user an instant hierarchical statement of how they arrived at the Tile on display, and to which level they may need to return to change the displayed Tiles, ie, do they need to go right back and change “family”, or just “Yukiko”.

As previously discussed, this hierarchical view is fundamentally different to conventional directory trees of Files in Folders in Folders. Categories and GridSets are potentially deletable, without deleting the tilefile packages they reference.

Certain Categories and GridSets will belong to the system and be undeleteable for reasons of practicality. For example, it would not be possible to delete the category “All my Grids”. This may be referred to as a Master category belonging to the system.

A special category of Grid is the “Buddy Grid” or “Team Grid”, or “Subscription Grid”. This is a subset of tiles completely private to user A and to a buddy or friend, or user A and their family, work group, or even to user A's subscription or service relationships. For example, a service selected at C could allocate special tilefile packages to individual members (e.g. help files in the form of a tilefile package), or a subset of targeted subscription material. In each case (Buddy Grid, Team Grid, Subscription Grid, Help Grid, etc) this is an alternative to an “in” and “out” box. Instead of filling up each other's in and out boxes, Users A and an individual or group at B or C may simply drag and drop or author tilefile packages into the shared grid that is completely private to those friends or that group or service relationship. The assets may remain server side and may be previewed without download, streamed, or selectively downloaded, whichever is desirable. Instead of representing the relationship between A and those at B or C as a list of headers (as in an email system), the relationship is represented as a visual tableau of the latest tilefile packages.

This shifts the emphasis from dull text to a vibrant Tableaux of the latest faces, photographs, videos and other images including “talking head” messages recorded by phone or webcam. tilefile packages may, however, still be used to convey text messages, if desired. The buddy, team, group or service etc. arrangement in effect means that one account may operate as multiple sub sites. In this sense the terms “website” and “webpage” may no longer be appropriate. Instead of referring to GRIDMO as a website, it is anticipated that users will refer simply to “my GRIDMO”, “your GRIDMO”, “put a tile in my GRID”, etc.

The relationship grids and the nature of the interaction of a user with the grid allows content to be distributed easily and quickly. Such a system lens itself to use in so-called “viral” promotional and marketing campaigns, since content is easily passed from on user to another.

Any Panel may be set as an empty grid or blank canvas for creating a new tile, or a new grid (menu tilefile package). This is achieved by a button “new” (FIG. 18, Numeral 62). In this instance, similar to the buddy grid process, tiles may be dragged and dropped or cut and pasted from various users and contexts into a compilation grid in the blank panel. During the process of authoring a new Tile or Grid, the “new” button becomes a drag and drop handle. This allows content from the panel where the authoring is taking place to be dragged to overlay one of the other panels, such that any content in any panel remains accessible during the authoring process, and such that it is possible to have at least two instances of the same panel on display at the same time. Any other permutation of these three panels may be possible, and user selectable. Alternatively, a number of “floating” canvases and inspectors may be implemented.

A tilefile package or new grid may then be saved (60) (and referenced as a tilefile package or menu tilefile package) for later reference. Filters may also exist to export a grid in an appropriate format, such as HTML or PDF.

Any grid may be opened and content dragged and dropped or otherwise rearranged, so that selecting the “save” button (60) results in the new sequence of tilefile packages in the interface being preserved.

The subordinate panels Aa, Bb, and Cc (FIG. 12) may be set to display a variety of tools and or information. For example a Timeline may be viewed which permits the filtering of Tiles via setting one or more sliders along a given time interval (dates interval). Individual tilefile packages or elements of tilefile packages may be searched for, and the scope of the search narrowed by selecting one or more buttons at (46). A tilefile package may be dragged and dropped into the Span tool (selected at button 36) the span results (38) may be displayed in the main panel allowing preview of the various presentation grids which reference this Tile.

Any subset of Tiles in a Grid may be highlighted in a specific order, such that that subset may be played back (FIG. 14A, Numeral 40). This may be accomplished by holding down a key such as the “shift” key, while mousing over each desired tile and clicking it. This will result in a coloured or otherwise highlighted frame appearing around the selected images (40).

If the “save” button (60) is selected while images are highlighted, this may automatically open a new grid and populate this grid with the highlighted sequence of Tiles. FIG. 16 Numeral 50 shows the “upload” screen of a Tile, where a new Tile may be authored by uploading information directly from the users hard drive. For example, a face fpr the Tile may be uploaded or changed at (52), and the attachments may be uploaded at (54).

In FIG. 14b, panels B and C are each filled with grids of Tiles, however panel A demonstrate that any tile may be enlarged to fill or partially occlude a panel, and various menu systems may be applied to or within these tiles. (Also the circle menu, panel B in 14a).

When a tile is enlarged such that it occludes the grid of Tiles out of which it arises, those Tiles may be reset to display in the subordinate panel at Aa. This way a visual reference to context is maintained. For example, if Panel A is set to a 3×3 matrix of 9 tiles, and a single Tile then occludes all 9 tiles, there is enough space in Panel Aa for all 8 other images to be displayed in a 6 wide matrix (and also for 4 additional images from the grid to be displayed).

In one aspect of the menu system, when a user passes their mouse over any tilefile package in the interface (of any size), one of a number of horizontal control bars switches on and appears layered over the image, depending which exact horizontal subdivision of the tile the mouse is “hovering” over. These bars switch off again as the mouse passes out of that specific region of the tile. In FIG. 13, 4 horizontal control bars (02) are all shown simultaneously over enlarged tiles in panels A and B for ease of explanation. Normally, only one control bar shows at a time, for as long as the mouse is hovering over its otherwise invisible location. See page 28 for a full description of the functionality of these bars.

When selected an animation is applied to the tilefile package, such that it appears to be turning around or “flipping” to reveal its reverse side. On this “reverse side” various other assets and controls may be revealed, such as other secondary images, attachments, security data, log comments, and other meta data. The creator of a tile may elect to not permit viewers to be able to “flip” the tile, in which case the flip button will be deactivated, or the flipping event may be password protected.

When a tile has been flipped, a similar control arrangement to that on the front of the tile may operate on the back of the tile, allowing the tile to be turned back to reveal its front once more, and allowing enlargement and various other navigation processes that apply to the front of the tile. In this sense, the “back” of a tile is an interface concept intended to make an intuitive, high level subdivision in the menu system that mediates the various processes that may be applied in the ongoing creation and maintenance of a tile, such as the addition of text comments or images by other viewers, voice annotations, sharing features, or changes in the level of security applied to a tile.

This halo of control menus (22) means that the user doesn't have to keep moving the mouse a great distance from the tile of interest. The menus or commands, which appear in the circle around the tile, typically represent actions which may be performed “upon” a tile, as opposed to actions which may be performed “within” the operating environment of the tile itself. In other words, the actions described in the halo menu are applied to the package as a whole. However, in the case of menu items such as “share” there may be a sub menu which allows the action to be limited to specific subsets of the tile's assets.

In either case, these actions do not normally affect changes to the tile itself, but rather are applied to the tile as it is, or to aspects of the tile as it is.

Various operating menus (14b numeral 30) or buttons may entry into different levels or layers of a tilefile package. These menus apply directly to that specific tile, permitting various additions and changes to the “world” of that tile, such as attaching files such as a document, removing files, changing the relationship between assets, adding commentary to the tile, trimming the in and out points of a video clip, etc. These menus may also permit selective extraction (e.g. downloading) of various aspects of the Tile, without necessarily changing the status of the tile.

Multiple tiles may be chosen and selected for consecutive playback of the front of tile (representative) content. For example, a group of photographs may be played back as a single slide show, or a group of video clips may be set to play back as though they were all edited together, or a hybrid video clip plus slide show sequence may be selected to play.

Furthermore, Tiles may contain unique scripts which enhances their behaviour during playback, or which trigger secondary processes when the Tile is played or otherwise selected.

In the graphical user interface there may be other menu systems (FIG. 14b, numeral 24, 26) applying not to individual tiles, but to whole panels of tiles, and to ancillary functions, such as “signing up”, or searching and filtering the entire collection of the users TileFiles, another users TileFiles, or perhaps even every TileFile in the network of servers or in some sub-network or subset of servers. These menus may also facilitate the searching of various global libraries of tiles or assets, such as audio loops, the creating and saving of subsets of tiles, the publishing of these subsets as conventional websites, the application of a variety of different “skins” (appearances) to individual tiles, whole sites or published pages, the switching on of teleconferencing, chat, or messaging features, email invitations to other individuals to sign up, and so forth. They may further facilitate the function of pushing assets or tiles back out to phones or other mobile devices.

The “header bar” of the interface (the title bar above the 3 main panels) may contain a special subclass of tilefile packages which mediate the various preferences and settings for the site. These tilefile packages may be shared like any other, so that one user may share their preferences and perhaps skins with other users.

A Website Implementation of the Tilefile Package File Type and the Graphical User Interface

The tilefile package product is implemented, in one embodiment, as a service called “GridMo” (“Grid”+“Mobile”). In GridMo tilefile packages form a unit of display and exchange in a content aggregation, publishing and file sharing website. GridMo is a sharing or messaging community, and as a centralised service, it bares a superficial resemblance to a web-based email service or a blog. However, a GridMo account is entirely modular (being made up of tilefile packages). The Gridmo user interface (GMUI) is predominantly visual (being based around grids of tilefile packages, each with their own instance of a TFUI), and is particularly suited to video presentations, “slideshows” (of photographs or slides), and is capable of sequencing still images and videoclips together into a hybrid show. FIGS. 12 to 19 show various views of the GridMo interface.

With GridMo, tilefile packages are formed at the server. Photographs, video clips and text may be sent into GridMo accounts from mobile phones including via email, mms, or via a dedicated application (see FIG. 11).

For example, when a user emails a photograph or video clip to their GridMo account, the GridMo daemon may receive the message and invoke a script to process it. This script puts the image into an empty tilefile package, and saves it to the users account, to be viewed when the user next accesses or refreshes their display.

Once a photograph or video clip has been placed in an “empty” tilefile package in this manner, the new tilefile package is accessible and so it forms a hub into which other content may be aggregated. For example, if the user allows the file to be viewed and manipulated by other users, the other users may also log their remarks into the tilefile package, and may add photographs of their own to the body of the tilefile package, so that the initial photograph forms the root of a collection of photographs and comments (eg on a given subject, such as a news story, or a wedding).

Alternatively, a client side other application may be made available, with which a user can take manipulate tilefile packages offline.

Since GRIDMO accounts are built around the aggregation of tilefile packages, the GRIDMO server may be machine independent and simply require the installation of the correct version of “TILESERVER”. This server application is the backbone of GridMo.

“Grid” or “go” may be the service prefix attached to a GridMo service, so that viewers simply navigate to the site servers via DNS. For example, the prefix “grid” in a URL such as http://grid.gridmo.com may denote a gridmo server, in the same way that the prefix “www” in a URL denotes a web server.

Individual tilefile packages are stored and each user site may be a folder on the database. Each tilefile package has a name within the database, and the asset to be displayed is set in the link properties. For example, ?LinkAsset=14, would lead a viewer to the tilefile package at the level of asset 14.

tilefile packages rely upon a form of de-centralised or distributed database, avoiding the pitfalls of a centralised system, since the database structure is created dynamically, as required.

Any tilefile package database may be abstracted away from the physical layer. The location of all files on the server can potentially be stored in memory, so that a request to a file can quickly be matched. When a particular tilefile package is being used, or another tilefile package in the relation is changed, the only information that need be accessed or instanced is information which is relevant to the particular relational grouping, and is contained within the files of that grouping. This increases speed, cuts down search time and increases redundancy, making it easier to cluster huge systems.

A possible implementation of this approach may be a Linux server running Python, Apache and MySQL. In this scenario, the GridMo server runs resident in memory either as an Apache Module or simply as a stand-alone program.

The GridMo server listens on Port 80 for HTTP requests, which are then resolved to their final destination. The location of all files on the server are stored in memory so it can quickly match a request to a file. A MySQL database is used to build a list of files and locations and properties. On restart the server reads from its static memory (SQL DB) and instantiates the Associative Array of Tile locations and tile names and properties into memory. This is a simple powerful system for storing and retrieving all files. Passwords are stored either with the files or in a separate file with the server. The GridMo server, on receipt of a request, checks the properties of the file. If the file is protected the server requests a login and password. Once the user is verified the server creates a stream to the Client (GridMo Viewer) and the client can view the tile.

tilefile packages are generally created at the server, so the restricted access of this methodology protects any intellectual property in the file, because a new file can only be created via the Tile Server. As previously stated, an offline software application dubbed “tilefile packagePro” may be utilised to create and archive offline as well as online files, and various other applications may be developed for importing, manipulating, or exporting tilefile packages.

A GridMo server may incorporate a “thin client” to allow upload of content from mobile phones and smart devices, and there may also be a layer to facilitate browsing from these devices.

A professional version of tilefile package and the GridMo server may include various forms of digital rights protection. Individual tilefile packages may be only available on a “pay per view” basis, offering a preview (the face), but not permitting access to the remainder of the tile unless payment is received.

Digital rights protection may be built into the format of the file. The key which is required to un-encrypt the file may be stored on the GridMo server. When a viewer provides their personal key (e.g. a credit card number), the GridMo server then supplies the client with the key and wipes the key from the client once viewing of the file is completed. Saving the file may still require a request for the key to be sent to the server before viewing is possible.

Viewing one or more tilefile packages on a GridMo server may require the use of a browser plug-in, and it may also be possible without a plug-in.

In one implementation, viewing capabilities may be created by use of various code libraries, which may include the following:
MPEG4 Codec (Video)
MPEG2 Codec (Video)
BASS Sound System (Sound Windows™ only)
Open Source Audio Library Project (Sound any OS)
ImageMagick (Images)
Rich Text Display systems
Flash Display Libraries
Shockwave Display Libraries.

In at least the GridMo embodiment, multiple tilefile packages may be represented by a single image in a user interface. In this interface, actions upon the representative images mediate actions upon the media packages as a whole. For example, more than one media package may be grouped or linked by grouping or linking the representative images within the user interface (that is, grouping or linking of the representative images at the level of the user interface results in the grouping of the tilefile packages at a lower level in the system). The representative images may be grouped as a matrix in a grid-like pattern, or as some other grouping, cluster or tableau of multiple images. By migrating images in the user interface, it is possible to migrate packages to a new position within a grouping of packages, or from one grouping to another grouping, generating new inter relationships between the packages and their constituent elements.

Advantages

As may be seen from the previous description, a tilefile package exists to be grouped, regrouped, and exchanged between contexts. In a tilefile package, the modular containment of disparate entities is preferably designed to streamline and simplify the processes of:
1. aggregating content into standardised containers;
2. displaying these containers in an intuitive user interface for easy manipulation;
3. grouping, storing, transporting and exchanging these containers;
4. building a new class of website out of these containers;
5. transporting these containers between applications and between the on and offline environments;
6. better integrating smart devices (such as phones) and the Internet;
7. displaying and possibly selling the contents of containers;
8. displaying the contents of an entire group or sequence of containers; and
9. Forming a new class of data repositories from which content may be “pushed out” to phones.

With tilefile packages, Internet sites may take on new form of standardization, so that instead of static web sites, there are provided sites that are more like a port or hub at which uniform containers of highly disparate items can be meaningfully grouped, maintained, imported and exported, throughout the digital world. tilefile packages are designed to deal with the specific demands of time based media, such as video clips, they have the potential to blur the boundary between websites, presentations, file sharing, and messaging. The tilefile package is designed for both on and offline usage (on the container ship, and on land). Furthermore, as a standardized container into which to aggregate content, any single tilefile package may receive content from various sources, for example, a photograph from a mobile phone, and a text comment entered from a PC. This means tilefile packages may radically streamline the relationship between mobile phones and the Internet.

Although the preferred embodiment of the invention is a file type that contains other files, it should be recognized that a useful standardised sub grouping of elements may also be possible with a data structure that is not stored with a single file. Although the preferred embodiment of the application is with the tilefile package as a container document (file type) The GridMo interface could still be applied to more abstract grouping of elements. It will be understood that in its broadest conception, a media package includes this abstraction.

1. A media package comprising:
means for storing or referencing a plurality of presentation elements, the media package being associable with at least one other media package in order to link the plurality of presentation elements between the media package and the at least one other media package, wherein any one of the plurality of presentation elements is manipulable by a user.

2. The media package in accordance with claim 1, wherein at least one of the plurality of presentation elements is manipulated by at least one of removing, inserting, modifying and altering the presentation element contained within the media package.

3. The media package in accordance with claim 2, further comprising a linking structure operative to associate the media package with the at least one other media package so as to link the plurality of presentation elements to provide a time based presentation.

4. The media package in accordance with claim 3, wherein the linking structure is operable to establish a bi-directional link with the media package and the at least one other media package.

5. The media package in accordance with claim 4, wherein, when a bi-directional link is established, the linking structure is operative to include a variable in said link, the variable being operative to define one link as the primary link and the other link as the secondary link.

6. The media package in accordance with claim 5, wherein any one of the primary and secondary link establishes a sequence in which the plurality of presentation elements are linked so as to form a continuous presentation.

7. The media package in accordance with claims 3, wherein, on movement or modification of the media package, the media package causes a dummy file to be retained containing at least a sub-set of links of the media package, such that the other media packages referencing the media package are not affected by the movement or modification of the media package.

8. The media package in accordance with claim 7, wherein the dummy file is a duplicate of the media package.

9. The media package in accordance with claim 3, wherein, on movement or modification of the media package, the media package modifies the linking structure.

10. The media package in accordance with claim 3, wherein, on movement or modification of the media package, the media package modifies at least a sub-set of links of the linking structure.

11. The media package in accordance with claim 10, wherein the at least sub-set of the links is updated only when one of the other media packages attempts to access the moved or modified media package.

12. The media package in accordance with claim 1, wherein, on conducting a search for similar media packages, the search returns a sub-set of media packages which are referenced by the media package, the sub-set returned being determined by a predetermined criteria.

13. The media package in accordance with claim 1, further comprising a header section and a binary information store, the header section containing associability information indicating the associability of the media package with the at least one other media package, and the binary information store containing at least one of the plurality of presentation elements.

14. A method of delivering a media package comprising means for storing or referencing a plurality of presentation elements, the media package being associable with at least one other media package in order to link the plurality of presentation elements between the media package and the at least one other media package, wherein any one of the plurality of presentation elements is manipulable by a user, wherein the media package further comprises a header section and a binary information store, the header section containing associability information indicating the associability of the media package with the at least one other media package, and the binary information store containing at least one of the plurality of presentation elements, the method comprising:
delivering at least a sub-set of the associability information to an end user and a representation of at least one of the plurality of presentation elements; and
delivering at least a portion of the binary information store to the user in response to a user request for the at least a portion of the binary information store.

15. A method of generating a user generated database comprising:
providing a plurality of media packages;
storing presentation elements of a presentation in respective ones of the media packages; and
linking the media packages so as to associate the presentation elements of the presentation.

16. A system for authoring, editing, storing and delivering a media package comprising means for storing or referencing a plurality of presentation elements, the media package being associable with at least one other media package in order to link the plurality of presentation elements between the media package and the at least one other media package, wherein any one of the plurality of presentation elements is manipulable by a user, the system comprising storage capable of storing the media package, and a software application capable of delivering the media package to a client application on receipt of a request from the client application for the media package.

17. The system in accordance with claim 16, wherein, on receipt of a command from a media package to move or modify the media package, the system causes a dummy file to be retained containing at least a sub-set of the original links of the media package, such that the other media packages referencing the media package are not affected by the movement or modification of the media package.

18. The system in accordance with claim 16, wherein, on receipt of a command from a media package to move or modify the media package, the system causes all links of all of the other media packages referencing the media package to be updated to reflect the modification or movement of the media package.

19. The system in accordance with claim 16, wherein, on receipt of a command from a media package to move or modify the media package, the system causes all links of the other media packages referencing the media packages to be updated to reflect the modification or movement of the media package only when one of the other media packages attempts to access the moved or modified media package.

20. The system in accordance with claim 16, further comprising a search engine capable of reviewing the media packages stored and compiling a searchable index.

21. A graphical user interface for displaying a plurality of associable media packages that include means for storing or referencing at least one presentation element, the graphical user interface comprising a plurality of display sections selectable by a user, including a first display section containing representations of media packages unique to a user, a second display section containing representations of media packages unique to other users, and a third display section arranged to allow authoring, editing or viewing of the media packages unique to the user or the other users.

22. The graphical user interface in accordance with claim 21, further comprising a menu system viewable by selecting a media package contained within any one of the display sections, the menu system providing the functionality to manipulate the representation of the media package displayed therein.

23. The graphical user interface in accordance with claim 22, wherein the menu system further provides the functionality to navigate from the media package to other media packages.

24. The graphical user interface in accordance with claim 23, wherein the menu system overlays the representation of the media package.

25. The graphical user interface in accordance with claim 24, wherein the menu system further comprises a plurality of regions which overlay the representation of the media package, the regions being arranged to become visible on movement of a cursor over the media package.

26. The graphical user interface in accordance with claim 21, further comprising a second menu proximal to each of the plurality of display sections, the second menu providing the functionality to manipulate the media packages represented therein.

27. The graphical user interface in accordance with claim 26, wherein manipulation of the media package includes the functions of copying the media package, editing the media package, deleting the media package and moving the media package to a new context.

28. The graphical user interface in accordance with claim 27, wherein the manipulation of the representation of the media package includes the functions of viewing a primary presentation element and viewing any of the further presentation elements.

29. The graphical user interface in accordance with claim 28, wherein, in response to a user command, the representation of the presentation element transforms from the representation to a different representation of the other presentation elements in the media package.

30. The graphical user interface in accordance with claim 29, wherein the transformation occurs through a virtual rotation of the representation, from a front face to a rear face.

31. The graphical user interface in accordance with claim 21, wherein the second display area is limited to viewing representations of media packages accessible by only a sub-set of users.

32. The graphical user interface in accordance with claim 21, wherein the display sections contain at least one representation of a media package, the representation being provided within a pre-defined pattern.

33. The graphical user interface in accordance with claim 32, wherein the defined pattern is a grid pattern.

34. The graphical user interface in accordance with claim 21, wherein a layout of the graphical user interface is determined by the contents of a selected media package.

35. A graphical user interface for displaying a plurality of associable media packages that include means for storing or referencing at least one presentation element, the graphical user interface comprising a menu system viewable by selecting any one of the plurality of associable media packages, the menu system providing the functionality to view or manipulate the selected one of the plurality of associable media packages displayed therein, wherein the menu is associated with the selected one of the plurality of associable media packages.

36. A graphical user interface comprising at least one viewing area arranged to display media content, wherein the layout of the graphical user interface is at least in part determined by the media content displayed in the at least one viewing area and the layout of the graphical user interface includes at least one menu system, the functionality of the menu system being determined by the media content displayed in the at least one viewing area.

37. The graphical user interface in accordance with claim 36, wherein the menu system surrounds or is proximal to the viewing area.

38. The graphical user interface in accordance with claim 37, the menu system including two sub-menus, the first sub-menu providing controls to manipulate the media content, the second sub-menu providing controls to manipulate the viewing of the media content in the interface.

39. The graphical user interface in accordance with claim 36, wherein at least one of the viewing areas is further divided into a plurality of sub-areas capable of displaying a representation of a media package.

40. The graphical user interface in accordance with claim 36, further comprising blogging means for interfacing with a media package, the blogging means being capable of editing text comments in the media package.

41. A system for viewing a plurality of media packages, comprising a computing system arranged to deliver at least a sub-set of at least one media package to a graphical user interface, wherein the media package comprises means for storing or referencing a plurality of presentation elements, the media package being associable with at least one other media package in order to link the plurality of presentation elements between the media package and the at least one other media package, wherein any one of the plurality of presentation elements is manipulable by a user, and further wherein the media package includes information that is used in establishing at least one characteristic that is operative in the graphical user interface.

42. A method of unifying presentation elements contained in a plurality of media packages, the media packages comprising means for storing or referencing a plurality of presentation elements, the media package being associable with at least one other media package in order to link the plurality of presentation elements between the media package and the at least one other media package, wherein any one of the plurality of presentation elements is manipulable by a user, the method comprising:
selecting a series of media packages;
extracting a sub-set of the plurality of presentation elements from the selected media packages;
selecting a series of presentation elements not contained within a media package; and
constructing a further media package containing the extracted sub-set of presentation elements and the selected series of presentation elements not contained within a media package.

43. A system for delivering a presentation including presentation elements from a plurality of media packages, comprising a device including a software application arranged to receive at least a sub-set of at least one media package and to display the at least one sub-set of the at least one media package to a user, wherein the at least one media package comprises means for storing or referencing the presentation elements, the media package being associable with at least one other media package in order to link the presentation elements between the media package and the at least one other media package, wherein any one of the plurality of presentation elements is manipulable by a user.

44. The system in accordance with claim 43, wherein the software application displays the at least one received sub-set of the at least one media package as a syndication stream.

45. The system in accordance with claim 43, wherein the at least one media package contains streamed data.

46. The system in accordance with claim 45, wherein the streamed data is a live source, such as a video conference call.

47. A method of providing a self-executing media presentation to a user, the method comprising:
grouping at least one presentation element into a media package, the media package comprising means for storing or referencing the at least one presentation element, the media package being associable with at least one other media package in order to link the plurality of presentation elements between the media package and the at least one other media package, wherein any one of the plurality of presentation elements is manipulable by a user; and
providing the media package to the user, wherein the user may view the at least one presentation element.
